(19) United States
(12) Patent Application Publication
(10) Pub. No.: US 2026/0327381 A1
(43) Pub. Date: Oct. 22, 2026

(54) SOLUTION PROCESSING OF CONDUCTIVE THIN FILMS

(71) Applicant: The University of Chicago, Chicago, IL (US)

(72) Inventors: Patrick Crossland, Lewisburg, PA (US); John S. Anderson, Chicago, IL (US)

(73) Assignee: The University of Chicago, Chicago, IL (US)

(21) Appl. No.: 19/287,166

(22) Filed: Jul. 31, 2025

Related U.S. Application Data
(60) Provisional application No. 63/677,740, filed on Jul. 31, 2024.

(51) Int. Cl. C08G 79/12; C08G 77/00; C09D 5/24; C09D 183/00; C09D 185/00; D06M 15/643; D06M 15/687

(52) U.S. Cl. CPC C08G 79/12; C08G 77/00; C09D 5/24; C09D 183/00; C09D 185/00; D06M 15/643; D06M 15/687

(57) ABSTRACT

Methods of preparing coordination polymers comprising transition metal ions and tetrathiafulvalenetetrathiolate (TTFtt) via solution phase processing are described. The methods include depositing a solution of a charged coordination polymer on a substrate to form a thin film. The thin film can then be oxidized via contact with an oxidant-containing solution to transform the charged coordination polymer to a conductive metal-TTFtt coordination polymer. Thin films of the conductive coordination polymer can be provided as coatings on a variety of substrates, including fibers and textiles. The thin films of the conductive coordination polymers show higher conductivity than the same polymer when provided as a powder.

### CROSS REFERENCE TO RELATED APPLICATION

This application claims benefit of and priority to U.S. Provisional Application Ser. No. 63/677,740, filed Jul. 31, 2024, the disclosure of which is incorporated herein by reference in its entirety.

### STATEMENT OF GOVERNMENT SUPPORT

This invention was made with government support under W911 NF-23-1-0233 awarded by the Army Research Laboratory—Army Research Office. The government has certain rights in the invention.

### TECHNICAL FIELD

The presently disclosed subject matter relates thin films comprising coordination polymers (e.g., conductive coordination polymers) comprising repeating coordination complexes of transition metals ions and tetrathiafulvalene-2,3,6,7-tetrathiolate (TTFtt), to methods of making the thin films using solution processing, and to coated objects comprising the thin films, including, for example, coated textiles for use as wearable electronics or as electromagnetic shielding materials.

### Abbreviations

° C.=degrees Celsius
%=percent
μm=micrometer
μM=micromolar
3D=three-dimensional
AcO=acetyl
AFM=atomic force microscopy
BAr^{F}₄=tetrakis(3,5-bis(trifluoromethyl)-phenyl) borate
Bu=butyl
cm=centimeter
CP=coordination polymer
DCM=dichloromethane
DMF=dimethyl formamide
EDS=energy-dispersive x-ray spectroscopy
ES=Efros-Shklovskii
Fc=ferrocenium
Fe=iron
g=gram
Ge=germanium
GIWAXS=grazing incidence wide angle x-ray scattering
K=Kelvin
MeCN=acetonitrile
MeOH=methanol
min=minutes
mL=milliliter
mmol=millimoles
Mn=manganese
NEt₄=tetraethylammonium
Ni=nickel
nm=nanometers
NMe₄=tetramethylammonium
OBz=benzoyl
Ph=phenyl
PXRD=powder x-ray diffraction
RMS=root mean square
S=sulfur
SEM=scanning electron microscopy
Si=silicon
SiO₂=silicon dioxide
S/cm=Siemens per centimeter
Sn=tin
THF=tetrahydrofuran
TTF=tetrathiafulvalene
TTFtt=tetrathiafulvalene-2,3,6,7-tetrathiolate
VT=variable temperature
XPS=x-ray photoelectron spectroscopy
XRF=x-ray fluorescence

### BACKGROUND

Since the discovery of polyacetylene in 1977, conducting organic materials have been studied for both their interesting properties and potential applications.^{1,2} Of this broad class of materials, conductive coordination polymers, which can include both inorganic and organic components, are of significant recent interest due to their innate modularity and tunability.

Accordingly, there is an ongoing need for conductive coordination polymers and methods of preparing them, particularly for methods where the conductive coordination polymers can be prepared as thin films or coatings.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

In some embodiments, the presently disclosed subject matter provides a method of preparing a coordination polymer, wherein the method comprises: (a) providing a first coordination complex having a structure of Formula (I):

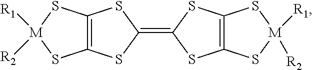

wherein: M is a first metal selected from Si, Ge, Se, and Sn; and R₁ and R₂ are independently selected from alkyl, aralkyl, and aryl; (b) preparing a first solution comprising one or more second coordination complex salts dissolved in a first solvent; wherein each of said second coordination complex salts has the formula [(A)₂M′X₄], where M′ is a transition metal ion, each X is a molecule or ion having an unshared pair of electrons; and each A is monocationic molecule or ion; (c) contacting the first coordination complex with the first solution, thereby forming a second solution comprising a coordination polymer having a structure of Formula (II):

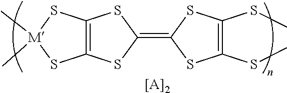

where n is an integer greater than 1, each M′ is a transition metal ion of a second coordination complex salt in the first solution of step (b), and each A is a monocationic molecule or ion from a second coordination complex salt in the first solution of step (b); and (d) depositing the second solution on a substrate, thereby forming a layer comprising the coordination polymer of Formula (II) on at least a portion of a surface of the substrate.

In some embodiments, M is Sn or Si. In some embodiments, R₁ and R₂ are each C₁-C₆ alkyl, optionally wherein R₁ and R₂ are each butyl.

In some embodiments, each M′ is selected from Fe, Cr, Mo, Ni, W, Co, Cu, Pt, Pd, V, Ru, Rh, Ir, Os, Re, Au, and Mn, optionally wherein the coordination polymer of Formula (II) comprises at least two different M′, further optionally wherein each M′ is Ni, Fe, Pt, or Co. In some embodiments, each X is a halide, optionally Cl or Br. In some embodiments, each A is ⁺N(R′)₄, wherein each R′ is H or C1-C6 alkyl, optionally methyl.

In some embodiments, the first solvent comprises a polar aprotic or protic solvent, optionally wherein the first solvent is dimethylformamide (DMF), dimethylsulfoxide (DMSO), or a mixture thereof. In some embodiments, step (b) comprises heating the first solvent, optionally wherein the heating comprises heating the first solvent to a temperature of about 60° C. to about 150° C. for a first period of time.

In some embodiments, the substrate comprises a textile, a fiber, silicon, glass, sapphire, metals, a thermosetting organic polymer, and/or a thermoplastic organic polymer. In some embodiments, the depositing comprises printing, spraying, drop casting, spin coating, and/or dip coating.

In some embodiments, the method further comprises (e) curing the layer formed in step (d), wherein said curing comprises drying the layer formed in step (d) to remove the first solvent and form a film comprising the coordination polymer of Formula (II). In some embodiments, the curing further comprises contacting the film comprising the coordination polymer of Formula (II) with a third solution for a second period of time, wherein the third solution comprises an oxidant and a second solvent, thereby converting the coordination polymer of Formula (III) into a conductive coordination polymer having a structure of Formula (III):

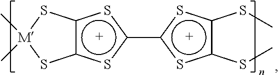

wherein n is an integer greater than 1 and each M′ is a transition metal of a second coordination polymer salt from step (b), optionally wherein the conductive coordination polymer of Formula (III) comprises at least two different M′ and/or wherein each M′ is Ni, Pt, Fe, or Co.

In some embodiments, the oxidant is a ferrocenium compound, optionally an acetyl ferrocenium compound or a benzoyl ferrocenium compound. In some embodiments, the ferrocenium compound is a salt of a borate anion, optionally wherein the borate anion is tetrakis(3,5-bis(trifluoromethyl)phenyl) borate. In some embodiments, the second solvent comprises chlorobenzene or dichloromethane.

In some embodiments, the presently disclosed subject matter provides a thin film comprising a conductive coordination polymer of Formula (III) prepared by a method as disclosed herein. In some embodiments, the thin film has a thickness of about 20 nanometers (nm) to about 3 micrometers (μm), optionally about 40 nm to about 150 nm. In some embodiments, the thin film has a conductivity of about 100 Siemens per centimeter (S/cm) or more, optionally about 500 S/cm to about 9000 S/cm.

In some embodiments, the presently disclosed subject matter provides a coated object comprising: (i) a substrate; and (ii) a coating layer covering at least a portion of a surface of the substrate, wherein the coating layer comprises a coordination polymer of Formula (II) or a conductive coordination polymer of Formula (III) prepared by a method as disclosed herein. In some embodiments, the substrate comprises a textile, a fiber, silicon, glass, sapphire, metals, a thermosetting organic polymer, and/or a thermoplastic organic polymer. In some embodiments, the coating layer has a thickness of about 20 nm to about 3 μm, optionally about 40 nm to about 150 nm.

In some embodiments, the presently disclosed subject matter provides a thin film comprising a conductive coordination polymer having a structure of Formula (III):

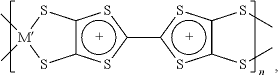

wherein n is an integer greater than 1 and each M′ is a transition metal, wherein said thin film has a thickness of about 20 nm to about 3 μm. In some embodiments, the thin film has a conductivity of about 100 Siemens per centimeter (S/cm) or more, optionally about 500 S/cm to about 9000 S/cm. In some embodiments, each M′ is selected from Fe, Cr, Mo, Ni, W, Co, Cu, Pt, Pd, V, Ru, Rh, Ir, Os, Re, Au, and/or Mn, optionally wherein each M′ is Ni, Pt, Fe, or Co. In some embodiments, the thin film is stable to air, brine, detergents, aqueous solutions comprising 1 molar (M) acid, and aqueous solutions comprising 1 M base.

In some embodiments, the presently disclosed subject matter provides a coated object comprising a thin film comprising a conductive coordination polymer having a structure of Formula (III).

In some embodiments, the presently disclosed subject matter provides the use of a coated object comprising a thin film comprising a conductive coordination polymer having a structure of Formula (III) in an electronic device.

In some embodiments, the presently disclosed subject matter provides a conductive textile comprising a thin film comprising a conductive coordination polymer having a structure of Formula (III) and a textile comprising one or more natural or synthetic fibers. In some embodiments, the textile comprises nylon fibers.

In some embodiments, the presently disclosed subject matter provides the use of a conductive textile comprising a thin film comprising a conductive coordination polymer having a structure of Formula (III) and a textile comprising one or more natural or synthetic fibers in a wearable electronic device.

In some embodiments, the presently disclosed subject matter provides a method of preparing a conductive coordination polymer comprising complexes of a transition metal ion and tetrathiafulvalenetetrathiolate (TTFtt), said method comprising deposition of a solution comprising a charged precursor coordination polymer and post-deposition oxidation.

Accordingly, it is an object of the presently disclosed subject matter to provide a method of preparing a coordination polymer (e.g., a coordination polymer of Formula (II) or a conductive coordination polymer of Formula (III)), as well as related thin films, conductive textiles, and coated objects, the uses thereof (e.g., in electronic devices).

An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 11B: NitTFtt thin films. FIG. 1A is a schematic diagram showing how NiTTFtt combines the properties of a wide range of materials. FIG. 1B is a schematic diagram showing a solution processing method of preparing a NiTTFtt thin film.

FIGS. 2A-2C: Characterization of NiTTFtt thin films. FIG. 2A is a graph showing the PXRD pattern of a NiTTFtt thin film on an Si/SiO₂ substrate. The lack of features shows that NiTTFtt remains amorphous after being deposited. FIG. 2B is a graph showing the height profile generated by laser measuring microscope of a NiTTFtt film. FIG. 2C is a series of SEM-EDS images of a NiTTFtt film showing even dispersion of Ni, C, and S, with minimal Sn left in the sample post deposition.

FIGS. 3A-3E: Transport measurements of a NiTTFtt thin film. FIG. 3A is a graph showing variable temperature sheet resistance and conductivity of a NiTTFtt thin film. FIG. 3B is a graph showing the Arrhenius plot of variable temperature conductivity data of a NiTTFtt thin film. The lack of a linear region indicates that NiTTFtt is not a semiconductor. FIG. 3C is a graph showing the Mott Variable-Range Hopping (MVRH) fit of VT conductivity data of a NiTTFtt thin film. The linear region above 10 K indicates that thermally driven hopping is the dominant mode of transport above that temperature. FIG. 3D is a graph showing the Efros-Shklovskii (ES) 1-D hopping fit of a NiTTFtt thin film. The linear region below 10 K shows that Coulomb gap develops and effects transport below these temperatures. FIG. 3E is a set of plots showing a qualitative representation of the band structure and filling for MVRH and ESH conduction mechanisms. In MVRH, localized bands in metallic regions allow for thermally driven hopping. ESH accounts for electron-electron repulsions that at low temperatures lead to the formation of a Coulomb gap and a decrease in the density of states at the Fermi level.

FIGS. 4A-4C: FIG. 4A is a graph showing reduced activation energy (W) of a NiTTFtt thin film as a function of temperature. FIG. 4B is a graph showing a plot of magnetoresistance vs. H² of a NiTTFtt thin film, demonstrating dominant ES hopping below 10 K. FIG. 4C is a graph showing magnetoresistance at 3 T at the given temperatures, as well as hopping distances and density of states at E_{F} computed from these values. After the metal-to-insulator transition density of states increases and hopping distance decreases.

FIGS. 5A-5C: FIG. 5A is a graph showing the in-air stability of a NiTTFtt film on a mylar substrate over the course of 20 days (red) and change in two-point resistance of a NiTTFtt-coated nylon fabric after 1000 bend cycles (blue). FIG. 5B is a composite photographic image of NiTTFtt-coated nylon fabrics completing circuits that illuminate a light-emitting diode (LED) before and after treatment with 1 M HCl and 1 M NaOH. FIG. 5C is a composite photographic image and table showing the effect of bending and straightening cycles on the two-point resistance of NiTTFtt-coated nylon fabrics.

FIG. 6 are (top) a pair of images showing a NiTTFtt film on a Si/SiO₂ substrate generated from a (NH₄)₂NiCl₄ precursor and (bottom) a height profile of the film. The image at the top left is an optical image and the image on the top right is a height image.

FIG. 7 are (top) a pair of images showing a NiTTFtt film on a Si/SiO₂ substrate generated from a (NMe₄)₂NiCl₄ precursor and (bottom) a height profile of the film. The image at the top left is an optical image and the image on the top right is a height image.

FIG. 8 are (top) a pair of images showing a NiTTFtt film on a Si/SiO₂ substrate generated from a (NEt₄)₂NiCl₄ precursor and (bottom) a height profile of the film. The image at the top left is an optical image and the image on the top right is a height image.

FIG. 9 is a pair of graphs showing the comparison in conductivity profiles between NiTTFtt films made with a NEt₄ (left) or NMe₄ (rights) precursor.

FIG. 10 is a pair of graphs showing the results of XPS sputtering studies on a NiTTFtt film on a Si/SiO₂ substrate prepared using a NMe₄ precursor. As the film surface is etched, no N peak is observed (left), indicating full oxidation of the film and no trapped NMe₄ cations. As etching continues, the Si peak becomes more prominent (right) until there is only bare Si surface being etched.

FIG. 11 is a graph showing the GIWAXS of a NiTTFtt film that shows no features, indicating films remain amorphous.

FIG. 12 is an AFM image (left) and height provide (right) of a 40 nm thick NiTTFtt film.

FIG. 13 is a series of AFM images and RMS Roughness values for selected areas in a 40 nm thick NiTTFtt film.

FIGS. 14A and 14B are SEM images of NiTTFtt films. FIG. 14A is a zoomed in image of a film showing lack of long-range structure. The scale bar in the upper left of FIG. 14A represents 1 micron. FIG. 14B is an SEM image of a hole in a 0.5 micron (μm) thick film, showing 2D sheets visible along the edge of the hole (see area highlighted in the box). The scale bar on the left side of FIG. 14B represents 10 μm.

FIG. 15 is (bottom) a graph showing the XRF spectra and (top) table of results of a NiTTFtt film on a Si/SiO₂ substrate.

FIG. 16 is a graph showing the full SPX spectrum of a NiTTFtt film on a Si/SiO₂ substrate. The Fe and Mn peaks are from steel in the instrumentation, while the O peak is from O₂ absorbed on the film surface.

FIG. 17 is a graph showing the Raman spectra of a NiTTFtt film (top) with relevant vibrations listed and the mylar substrate (bottom) the film was deposited on.

FIG. 18 is a pair of optical images showing (left) a 150 nm and (right) 40 nm thick NiTTFtt film.

FIG. 19 is graph showing the four-point voltage versus current plot for the most conductive NiTTFtt film, the slope gives resistance, in Ohms, which can be converted to conductivity by taking the inverse of the resistivity. Resistivity is found by multiplying resistance by (π/ln(2)) and the sample thickness (40 nm).

FIG. 20 is a graph showing conductivity versus temperature both on a logarithmic scale. The plot shows a change in conduction mechanism near 10 K.

FIG. 21 is an optical image showing a nylon-NiTTFtt fabric being dipped in a brine solution, with silver contacts being kept above the solution surface to avoid contamination. A similar protocol was used for HCl and NaOH solutions.

FIG. 22 is an optical image showing detergent washes to test conductive textile weathering.

FIGS. 23A to 23F are SEM images of uncoated nylon (FIGS. 23A to 23C) and nylon-Ni(TTFtt) (FIGS. 23D to 23F) fibers. In FIGS. 23B and 23C, the glowing, bright area is due to the charging effect caused by the insulating nature of nylon. Such an effect was not observed in FIGS. 23D to 23F, supporting that the Ni(TTFtt) coating increases the conductivity of the fabric.

### DETAILED DESCRIPTION

Conductive coordination polymers have generated great interest. However, these materials are typically generated as powders or single-crystals, which can limit processing options, and thus, the applications in which the polymers can be used. The presently disclosed subject matter relates, in one aspect, to a method that provides for solution-phase processing of highly-conductive TTFtt-containing coordination polymers, such as NiTTFtt, into thin films and conductive textiles. As described hereinbelow, thin films of NiTTFtt show record-breaking conductivity for a coordination polymer and unusual physical behavior that sheds light on transport mechanisms in this glassy metallic material. Textiles coated with NiTTFtt are conductive and durable to air, water, washing, acid, base, and mechanical cycles. The properties and processability of TTFtt-containing coordination polymers (e.g., NiTTFtt) reported here make them unique among coordination polymers and conducting organic materials more broadly.

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

Throughout the specification and claims, a given chemical formula or name shall encompass all optical and stereoisomers, as well as racemic mixtures where such isomers and mixtures exist.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Unless otherwise indicated, all numbers expressing quantities of size, temperature, time, weight, volume, concentration, capacitance, specific capacity, discharge capacity, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value is meant to encompass variations of in one example ±20% or ±10%, in another example ±5%, in another example ±1%, and in still another example ±0.1% from the specified amount, as such variations are appropriate to perform the disclosed methods.

Numerical ranges recited herein by endpoints include all numbers and fractions subsumed within that range (e.g. 1 to 5 includes, but is not limited to, 1, 1.5, 2, 2.75, 3, 3.90, 4, and 5).

As used herein the term “alkyl” can refer to C₁₋₂₀ inclusive, linear (i.e., “straight-chain”), branched, or cyclic, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C₁₋₈ straight-chain alkyls. In other embodiments, “alkyl” refers, in particular, to C₁₋₈ branched-chain alkyls.

The term “aryl” is used herein to refer to an aromatic substituent that can be a single aromatic ring, or multiple aromatic rings that are fused together, linked covalently, or linked to a common group, such as, but not limited to, a methylene or ethylene moiety. The aromatic ring(s) can comprise phenyl, naphthyl, and biphenyl, among others. In particular embodiments, the term “aryl” means a cyclic aromatic comprising about 5 to about 10 carbon atoms, e.g., 5, 6, 7, 8, 9, or 10 carbon atoms, and including 5- and 6-membered hydrocarbon aromatic rings.

The term “aralkyl” refers to an -alkyl-aryl group. An exemplary aralkyl group is benzyl (i.e., —CH₂—C₆H₅).

The terms “thiol” and “thio” as used herein refer to —SH or S⁻ groups.

The term “halide” as used herein refers to an anion selected from fluoride, chloride, bromide, and iodide.

The term “ammonium” as used herein can broadly refer to a quaternary ammonium cation (i.e., ⁺NR₄) wherein each R is independently selected from H, alkyl, aralkyl, and aryl. In some embodiments, ammonium refers to ⁺NR₄ wherein each R is selected from H and C₁-C₆ alkyl.

A “coordination complex” is a compound in which there is a coordinate bond between a metal ion and an electron pair donor, which can also be referred to herein as a “ligand” or “chelating group”. Thus, ligands or chelating groups are generally molecules or molecular ions having unshared electron pairs available for donation to a metal ion.

The term “coordinate bond” refers to an interaction between an electron pair donor and a coordination site on a metal ion or complex resulting in an attractive force between the electron pair donor and the metal ion or complex. The use of this term is not intended to be limiting, in so much as certain coordinate bonds also can be classified as having more or less covalent character (if not entirely covalent character) depending on the characteristics of the metal ion and the electron pair donor.

As used herein, the term “ligand” refers generally to a species, such as a molecule or ion, which interacts, e.g., binds, in some way with another species. More particularly, as used herein, a “ligand” can refer to a molecule or ion that binds a metal ion in solution to form a “coordination complex.” See Martell, A. E., and Hancock, R. D., Metal Complexes in Aqueous Solutions, Plenum: New York (1996), which is incorporated herein by reference in its entirety. The terms “ligand” and “chelating group” can be used interchangeably. Ligands typically have one or more donor groups (e.g., groups with unshared electron pairs) that can form a coordinative bond with a metal ion or complex. Groups with unshared electron pairs, include, but are not limited to, halide, —CO₂H, —NO₂, amino, hydroxyl, phenol, thio, thioalkyl, —B(OH)₂, —SO₃H, PO₃H, phosphonate, and heteroatoms (e.g., nitrogen, oxygen, or sulfur) in heterocycles. Ligands with a single donor group can be referred to as “monodentate”. Ligands with more than one donor group and which that can form more than one coordinative bond (with the same metal ion or complex or with multiple metal ions or complexes) can be referred to as “multidentate”, e.g., bidentate, tridentate, or tetradentate.

The term “bridging ligand” can refer to a group that bonds to more than one metal ion or complex, thus providing a “bridge” between metal ions or complexes. Organic bridging ligands can have two or more donor groups with unshared electron pairs separated by, for example, an alkylene or arylene group (i.e., a bivalent alkyl or aryl group). In some embodiments, the term “ligand” as described herein can refer to a group having two or more thio groups (e.g., TTFtt).

The term “coordination site” when used herein with regard to a ligand refers to an unshared electron pair, a negative charge, or atoms or functional groups cable of forming an unshared electron pair or negative charge (e.g., via deprotonation at a particular pH).

The terms “polymer” and “polymeric” refer to chemical structures that have repeating units (i.e., multiple copies of a given chemical substructure). Polymers can be organic (i.e., polymers that include carbon atoms in their backbone, such as polyolefins), inorganic (i.e., polymers that do not include carbon atoms in their backbone) or hybrid polymers that contain both inorganic and organic components. Polymers can be formed from polymerizable monomers. A polymerizable monomer is a molecule that comprises one or more moieties that can react to form bonds (e.g., covalent or coordinative bonds) with moieties on other molecules of same polymerizable monomer or another molecule comprising a different polymerizable monomer. In some embodiments, each polymerizable monomer molecule can bond to two or more other molecules/moieties. In some cases, a polymerizable monomer will bond to only one other molecule, forming a terminus of the polymeric material.

The term “coordination polymer” as used herein refers to a polymer comprising repeating units of coordination complexes, e.g., wherein a single ligand comprises a group coordinatively bound to one metal ion or metal cluster and another group coordinatively bound to a second metal ion or metal cluster.

The term “thermoplastic” can refer to an polymer that softens and/or can be molded above a certain temperature, but which is solid below that temperature. Thermoplastic polymers include, but are not limited to, ethylene vinyl acetate copolymers (EVA), polyolefins (e.g., polyethylene, polypropylene (PP), polyamides, some polyesters (e.g., polybutylene terephthalate (PBT)), styrene block copolymers (SBCs), polycarbonates, silicone rubbers, fluoropolymers, thermoplastic elastomers, polypyrrole, polycaprolactone, polyoxymethylene (POM), and mixtures and/or combinations thereof.

In contrast, the term “thermosetting” refers to an polymer that sets permanently when polymerized (e.g., via cross-linking). Examples of thermosetting polymers include, but are not limited to, some polyesters, melamine, silicones, epoxys, polyurethanes, and urea formaldehyde.

As used herein, the term “fiber,” refers to an elongated strand of material in which the length to width ratio is greater than about 10, greater than about 25, greater than about 50 or greater than about 100. A fiber typically has a round, or substantially round, cross section. Other cross-sectional shapes for the fiber include, but are not limited to, oval, square, triangular, rectangular, star-shaped, trilobal, pentalobal, octalobal, and flat (i.e., “ribbon” like) shape. The fiber can have any desired diameter, for example, thicker fibers (or “rods) can be chopped or pelletized, while thinner fibers can be used to prepare yarns or fabrics. In some embodiments, the fiber has a diameter of less than about 250 microns, less than about 200 microns, less than about 150 microns, less than about 100 microns, less than about 75 microns, less than about 50 microns, less than about 25 microns, or less than about 10 microns. In some embodiments, the fiber has a thickness of about 1 micron to about 250 microns. In some embodiments, the fiber has a thickness greater than about 250 microns. For example, thicker fibers or rods that can be chopped to provide pellets can have a thickness of a few hundred microns (e.g., about 300 microns, about 400 microns, about 500 microns, or about 750 microns) to a few millimeters (mm) (e.g., about 5 mm, about 10 mm, or about 25 mm).

The term “textile” as used herein refers to a fiber-based material that can be woven or non-woven (e.g., knit, felted, crocheted, braided, tatted, or bonded). Thus, the term “textile” as used herein includes, but is not limited to, yarns, threads, fabrics, and clothes.

The term “solvent” as used herein refers to a liquid that can dissolve a solute, such as the liquids typically used in the field of organic synthesis. Solvents can be categorized based as polar or nonpolar and as protic or nonprotic. Polar solvents typically have a relatively higher dielectric constant than nonpolar solvents. Nonpolar solvents can include, but are not limited to, alkanes (e.g., pentane, hexane, heptane, cyclohexane), some aromatic solvents (benzene and toluene), some ethers (e.g., diethyl ether and 1,4-dioxane), and some chlorocarbons (chloroform). Polar aprotic solvents can include, but are not limited to, dichloromethane (DCM), ethyl acetate (EtOAc), acetone, dimethylformamide (DMF), acetonitrile (MeCN), dimethyl sulfoxide (DMSO), dimethylpropyleneurea, hexamethylphosphoramide (HMPA), pyridine, sulfolane, tetrahydrofuran (THF), and nitromethane. Polar protic solvents can include, but are not limited to, alcohols (methanol (MeOH), ethanol (EtOH), isopropanol (IPA), n-butanol, t-butyl alcohol, ethylene glycol), acids (formic acid or acetic acid (AcOH)), and water.

### II. General Considerations

Conducting organic materials are of interest for many applications. This broad class includes graphitic materials, such as graphite—which is thermally and electrically conductive;^{3,4} graphene—which is metallic;⁵ and carbon nanotubes (CNTs)—which can also be metallic and are used in a variety of applications,⁶⁻⁸ as well as conducting polymers such as polyaniline, polyacetylene and PEDOT:PSS.⁹⁻¹² While these materials have exceptional properties, but there are still many limitations. For example, graphitic materials can be highly anisotropic,³ and pure graphene and CNTs are difficult to synthesize on large scales, which limits potential application spaces.^{6,13,14} Conducting polymers frequently require heavy doping or exceptional purity, or both to be highly conductive.⁹⁻¹² These requirements can hinder device incorporation and stability. Other commercial products include conductive metal paints. These materials bypass some of the doping- and purity-dependent properties of conductive organic materials and are highly conductive.¹⁵ However, these materials lack synthetic tunability and they also suffer from more limited stability, i.e. towards corrosion.

Efforts to bridge this gap between processability, robustness, and tunability led to materials such as the molecular metals TTF-TCNQ (TTF=tetrathiafulvalene TCNQ=tetracyanoquinodimethane) and Ni(dmit)₂ TTF (dmit=4,5-dimercapto-1,3-dithiole-2-dithione), which are conducting and superconducting, respectively.^{16,17} However, these materials too require high crystallinity to achieve high conductivity which limits processability into devices.

Recent progress on coordination polymers (CPs) has shown that this relatively new class of materials can also be highly conductive, and the highly tunable and frequently porous nature of these compounds makes them particularly appealing for many applications.¹⁸ Recent studies on single crystals of conducting CPs have led to significant insights into their charge transport mechanisms. For instance, metallic behavior has been recently observed in single crystals of some CPs.¹⁸⁻²⁰ Studies of conducting CPs are also frequently done on polycrystalline films or pressed pellets which are complicated by potential contributions from grain boundaries in the polycrystalline material. As an example, the highest conductivity value for a CP was recorded on a polycrystalline film of Cu(BHT) (BHT=benzene-hexthiolate).^{21,22} Aside from measurement convolutions, single crystals, polycrystalline films, and pressed pellets also present limited opportunities for processing into devices thus limiting the application space for these materials. Some exciting progress has been made on this front with the use of conducting CPs as 3-D printing inks²³ or patterned onto other materials.²⁴

A new coordination polymer, i.e., NiTTFtt (TTFtt=tetrathiafulvalenetetrathiolate) has recently been reported.²⁵ See also U.S. Patent Application Publication No. 2022/0411445, the disclosure of which is incorporated herein by reference in its entirety. The structure of TTFtt (with the structure of TTF indicated by the dotted rectangle), a bridging ligand which can form coordination complexes with metal ions, such as Ni, to provide coordination polymers, is shown in Scheme 1, below. NiTTFtt is highly conductive despite an amorphous structure and its electronic structure is best described as a glassy metal. NiTTFtt is redox tunable.²⁶

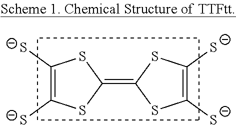 [SMILES: [S-]C1=C([S-])SC(=C2SC([S-])=C([S-])S2)S1]

In previous reports, NiTTFtt has been provided in powder form. However, according to the presently disclosed subject matter, and based on the observation of the enhanced solubility of reduced NiTTFtt congeners, a novel solution phase processing method for NiTTFtt and related coordination polymers is disclosed. This method can provide thin films of NiTTFtt and related coordination polymers, including thin film coatings (e.g., coatings having a thickness of 3 microns or less or 1 micron or less) of a variety of substrates, e.g., textiles, silicon, and plastics. As disclosed herein, deposited films of NiTTFtt have record conductivity for a coordination polymer—nearly a 4-fold increase over the previous highest reported value. They also shed light on transport mechanisms in this unusual glassy metal, and low-temperature data supports a disordered conductor to metal transition. The presently disclosed method for solution processing also provides for the fabrication of conductive synthetic fibers that retain the conductivity and highly robust properties of the parent material. It is believed that the presently disclosed subject matter represents the first instance of full solution processing of a conductive CP into a functional material. These findings both shed fundamental insight on this unusual material and also open up many possible applications across a range of fields.

### III. Solution Processing Methods and Thin Films

In some embodiments, the presently disclosed subject matter provides a method of preparing a coordination polymer (e.g., a conductive coordination polymer) comprising complexes of one or more transition metal ion and tetrathiafulvalenetetrathiolate (TTFtt) where the method comprises depositing of a solution comprising a coordination polymer (e.g., a charged precursor coordination polymer). In some embodiments, the method comprises performing post-deposition oxidation (i.e., oxidizing the charged precursor after deposition) to provide a conductive coordination polymer.

In some embodiments, the presently disclosed subject matter provides a method of preparing a coordination polymer involving a step comprising deposition of a solution comprising a charged coordination polymer. In some embodiments, the method comprises: (a) providing a first coordination complex having a structure of Formula (I):

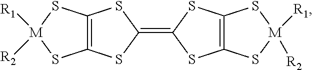

wherein: M is a first metal selected from Si, Ge, Se, and Sn; and R₁ and R₂ are independently selected from alkyl, aralkyl, and aryl; (b) preparing a first solution comprising one or more second coordination complex salts dissolved in a first solvent; wherein each of said second coordination complex salts has the formula [(A)₂M′X₄], where M′ is a transition metal ion, each X is a molecule or ion having an unshared pair of electrons; and each A is monocationic molecule or ion; (c) contacting the first coordination complex with the first solution, thereby forming a second solution comprising a coordination polymer having a structure of Formula (II):

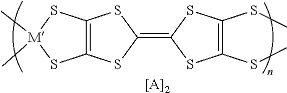

where n is an integer greater than 1 (e.g., greater than 10, greater than 50, greater than 100, greater than 500, or greater than 1000), each M′ is a transition metal ion of a second coordination complex salt in the first solution of step (b), and each A is a monocationic molecule or ion from a second coordination complex salt in the first solution of step (b); and (d) depositing the second solution on a substrate, thereby forming a layer comprising the coordination polymer of Formula (II) on at least a portion of a surface of the substrate.

The coordination complex of Formula (I) can act as a reagent to provide other compositions (e.g., coordination polymers) comprising TTFtt ligands via transmetallation reactions in step (c). In some embodiments, M is Sn. In some embodiments, M is Si. R₁ and R₂ can be any suitable hydrocarbon group. In some embodiments, R₁ and R₂ independently can be unsubstituted alkyl, unsubstituted aralkyl, or unsubstituted aryl (e.g., phenyl). In some embodiments, R₁ and R₂ are each C₁-C₆ alkyl (e.g., methyl, ethyl, n-propyl, isopropyl, n-butyl, isobutyl, n-pentyl, n-hexyl). In some embodiments, R₁ and R₂ are the same. IN some embodiments, R₁ and R₂ are different. In some embodiments, R₁ and R₂ are each butyl.

In some embodiments, the first solution comprises one second coordination complex salt. In some embodiments, the first solution comprises at least two (e.g., at least 2, 3, 4, 5, or 6) second coordination complex salts. In some embodiments, each second coordination complex salt comprises a different M′. Each M′ can be an ion of any suitable transition metal or combination of metals. In some embodiments, each M is independently selected from the group including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium, (Re), osmium (Os), iridium (Ir), platinum (Pt), and gold (Au). In some embodiments, each M′ is selected from the group including Fe, Cr, Mo, Ni, W, Co, Cu, Pt, Pd, V, Ru, Rh, Ir, Os, Re, Au, and Mn. In some embodiments, each M′ is Ni, Pt, Co, or Fe.

Each X in the one or more second coordination complex salts can be any suitable ligand that can form a coordination bond or bonds with a metal ion. Thus, each X is a metal ligand. In some embodiments, each X is a monodentate ligand. In some embodiments, each X of a particular second coordination complex salt are the same. In some embodiments, a second coordination complex salt can include at least two different X. In some embodiments, each X is a halide. In some embodiments, each X is Cl or Br.

Each A be any suitable monocationic molecule or ion. In some embodiments, each second coordination complex salt has a different A. In some embodiments, each A is an ammonium cation. In some embodiments, each A is ⁺N(R′)₄, wherein each R′ is H or C1-C6 alkyl (e.g., methyl, ethyl, n-propyl, isopropyl, n-butyl, etc.). In some embodiments, each R′ is methyl (i.e., P is ⁺N(Me)₄.

The first solvent can include any suitable solvent or mixture of solvents. In some embodiments, the first solvent comprises one or more polar aprotic and/or protic solvent. In some embodiments, the first solvent comprises or consists of DMF, DMSO, or mixtures thereof. In some embodiments, step (b) comprises heating the first solvent (e.g., to a temperature above room temperature, but below the boiling point of the first solvent). In some embodiments, the heating comprises heating the first solvent to a temperature of about 60° C. to about 150° C. for a period of time (e.g., sufficient to dissolve the second coordination complex salt or salts). In some embodiments, the first solution is filtered prior to step (c) to remove any undissolved solids.

In some embodiments, the first solution comprises a slight molar excess of the one or more second coordination complex salts compared to the first coordination complex (e.g., the total amount of second coordination complex salt is about 1.1 molar equivalents compared to the amount of first coordination complex). In some embodiments, the first solution comprises more than one second coordination complex salt, where each second coordination complex salt comprises a different M′ and the coordination polymer of Formula (II) comprises at least two different M′ (i.e., the coordination polymer of Formula (II) has different M′ ions in some monomeric units compared to other monomeric units).

The depositing of step (d) can be performed via any suitable method or methods, including, but not limited to, printing, spraying, drop-casting, spin coating, or dip coating. The substrate can be any suitable substrate. The substrate can be porous or non-porous, planar or non-planar. Suitable substrates include objects comprising materials selected from the group including, but not limited to, silicon, glass, sapphire, metal, metal alloys, metal oxides, and natural or synthetic polymers (e.g., thermosetting or thermoplastic polymers). In some embodiments, the substrate comprises a fiber or a textile. In some embodiments, the fiber or textile comprises nylon. In some embodiments, the substrate is a silicon wafer with a silicon dioxide surface.

In some embodiments, the deposited layer can have a thickness of about 20 nm to about 3 microns (e.g., about 20 nm, 40 nm, 60 nm, 80 nm, 100 nm, 150 nm, 200 nm, 250 nm, 300 nm, 400 nm, 500 nm, 600 nm, 700 nm, 800 nm, 900 nm, 1 micron, 1.5 microns, 2 microns, 2.5 microns, or about 3 microns). In some embodiments, the method further comprises (e) curing the layer formed in step (d). In some embodiments, the curing comprises drying the layer formed in step (d) to remove the first solvent and form a film comprising the coordination polymer of Formula (II). The drying can be performed via any suitable way, e.g., in a low temperature oven or at room temperature. In some embodiments, the film can have a thickness of about 20 nm to about 3 microns (e.g., about 20 nm, 40 nm, 60 nm, 80 nm, 100 nm, 150 nm, 200 nm, 250 nm, 300 nm, 400 nm, 500 nm, 600 nm, 700 nm, 800 nm, 900 nm, 1 micron, 1.5 microns, 2 microns, 2.5 microns, or about 3 microns).

In some embodiments, the curing further comprises contacting the film with a third solution for a second period of time, wherein the third solution comprises an oxidant and a second solvent, thereby converting the coordination polymer of Formula (III) into a conductive coordination polymer having a structure of Formula (III):

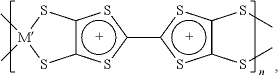

wherein n is an integer greater than 1 (e.g., greater than 10, greater than 50, greater than 100, greater than 500 or greater than 1000) and each M′ is a transition metal of a second coordination polymer salt from step (b). In some embodiments, the conductive coordination polymer of Formula (III) comprises at least two different M′. In some embodiments, each M′ is selected from the group including Fe, Cr, Mo, Ni, W, Co, Cu, Pt, Pd, V, Ru, Rh, Ir, Os, Re, Au, and Mn. In some embodiments, each M′ is Ni, Pt, Co, or Fe.

Any oxidant that can oxidize TTFtt can be used. In some embodiments, the oxidant is a ferrocenium compound, such as acetyl ferrocenium or benzoyl ferrocenium compound. In some embodiments, the ferrocenium compound is a salt of a borate anion, such as one of the borate anions described above. For instance, in some embodiments, the borate anion is tetrakis(3,5-bis(trifluoromethyl)phenyl) borate. Other suitable oxidants include, but are not limited to, silver(I) salts. In some embodiments, the third solution comprises at least one equivalent (i.e., at least one molar equivalent) of the one or more oxidant (e.g., about 1.0, about 1.1, or about 1.2 equivalents of oxidant) compared to the amount of TTFtt in the coordination polymer of Formula (II). In some embodiments, the third solution comprises at least about 2.0, 2.1, or 2.2 equivalents of oxidant. In some embodiments, the second solvent comprises a polar aprotic solvent. In some embodiments, the second solvent comprises chlorobenzene or dichloromethane. In some embodiments, the second period of time is about 4 hours to about 18 hours (e.g., about 4, 5, 6, 7, 8, 9, 10, 11, 12, 13, 14, 15, 16, 17, or about 18 hours). In some embodiments, the second period of time is about 10 to about 14 hours. In some embodiments, the second period of time is about 12 hours. In some embodiments, the contacting with the third solution can comprise submerging the film in the third solution. In some embodiments, the oxidized film (i.e., the film comprising the conductive coordination polymer of Formula (III)) can be rinsed, e.g., with DCM and/or MeOH.

In some embodiments, the presently disclosed subject matter provides a thin film comprising conductive coordination polymer of Formula (III) prepared according to a method as described herein. In some embodiments, the thin film has a thickness of about 20 nm to about 3 microns or of about 20 nm to about 1 micron. In some embodiments, the thin film has a thickness of about 40 nm to about 150 nm (e.g., about 40, 50, 60, 70, 80, 90, 100, 110, 120, 130, 140 or about 150 nm).

In some embodiments, the thin film comprising the conductive coordination polymer of Formula (III) has a higher conductivity that the conductive coordination polymer of Formula (III) when prepared via using a different method and/or in a solid (e.g., powder) form. In some embodiments, the thin film has a conductivity of about 100 Siemens per centimeter (S/cm) or more. In some embodiments, the thin film has a conductivity of about 500 S/cm or more. In some embodiments, the thin film has a conductivity of about 1300 S/cm or about 1500 S/cm or more. In some embodiments, the thin film has a conductivity of about 500 S/cm to about 9000 S/cm (e.g., about 500, 600, 700, 800, 900, 1000, 1500, 2000, 2500, 3000, 3500, 4000, 4500, 5000, 5500, 6000, 6500, 7000, 7500, 8000, 8500, or about 9000 S/cm).

In some embodiments, the presently disclosed subject matter provides a coated object comprising: (i) a substrate; and (ii) a coating layer covering at least a portion of a surface of the substrate, wherein the coating layer comprises a coordination polymer of Formula (II) or a conductive coordination polymer of Formula (III) prepared a method as disclosed herein. In some embodiments, the substrate comprises a textile, a fiber, silicon, glass, sapphire, metals, a thermosetting polymer, and/or a thermoplastic polymer. In some embodiments, the coating layer has a thickness of about 20 nm to about 3 μm. In some embodiments, the coating layer has a thickness of about 40 nm to about 150 nm. In some embodiments, the coated object can be provided for use as part of an electronic device (e.g., a wearable electronic device).

In some embodiments, the presently disclosed subject matter provides a thin film comprising a conductive coordination polymer having a structure of Formula (III):

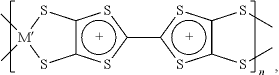

wherein n is an integer greater than 1 (e.g., greater than 10, greater than 50, greater than 100, greater than 500 or greater than 1000) and each M′ is a transition metal, wherein said thin film has a thickness of about 20 nm to about 3 μm (e.g., about 40 nm to about 150 nm). In some embodiments, the thin film has a conductivity of about 100 S/cm or more. In some embodiments, the thin film has a conductivity of about 500 S/cm or more. In some embodiments, the thin film has a conductivity of about 1300 S/cm or about 1500 S/cm or more. In some embodiments, the thin film has a conductivity of about 500 S/cm to about 9000 S/cm. In some embodiments, each M′ is selected from Fe, Cr, Mo, Ni, W, Co, Cu, Pt, Pd, V, Ru, Rh, Ir, Os, Re, Au, and/or Mn. In some embodiments, each M′ is Ni, Pt, Co, or Fe. In some embodiments, each M′ is the same. In some embodiments, the conductive coordination polymer comprises at least two different M′.

The presently disclosed thin film is stable to a variety of conditions, including exposure to air, water, brine (e.g., saturated NaCl), detergents (e.g., laundry detergents), and acidic or basic solutions (e.g., aqueous solutions comprising 1 M acid or base, such as 1 M HCl or 1 M NaOH).

In some embodiments, the presently disclosed subject matter provides a coated object comprising the thin film of the conductive coordination polymer of Formula (III). In some embodiments, the presently disclosed subject matter provides an electronic device comprising the coated object and/or the use thereof.

In some embodiments, the presently disclosed subject matter provides a conductive textile comprising a thin film of a conductive coordination polymer of Formula (III). Thus, in some embodiments, one or more (or all) of the fibers in the textile can have a thin film coating of the conductive coordination polymer covering at least part of the surface of the fiber. The textile can comprise one or more natural and/or synthetic fibers (e.g., cotton, wool, silk, polyamide (e.g., nylon), polyester, glass, carbon, etc). In some embodiments, the textile comprises nylon fibers. In some embodiments, the textile comprises a woven fabric. In some embodiments, the conductive textile can be used as or provided as part of a wearable electronic device.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

Solution Processing of Ni(TTFtt) into Thin Films

All chemicals were purchased from commercial vendors and used without further purification unless otherwise specified. All chemical reactions were performed under an inert atmosphere in a glovebox unless otherwise specified.

Synthesis of (Cation)₂NiCl₄ Compounds:

(NEt₄)₂NiCl₄ was synthesized according to literature procedures.⁴⁰ A similar methodology was employed for the NH₄ and NMe₄ compounds where methanol was substituted for ethanol. These syntheses gave a white powder, which upon recrystallization from hot dimethylformamide gave blue crystals.

Solution Processing of Ni(TTFtt) into Thin Films:

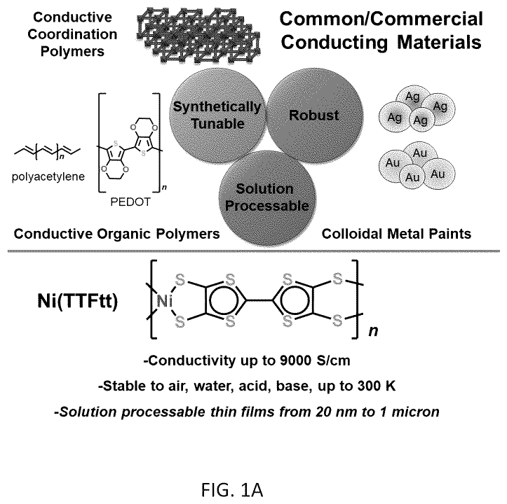

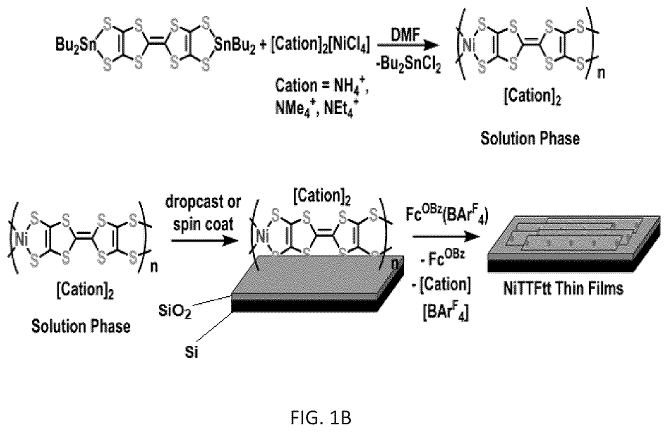

A schematic diagram showing a solution processing method for preparing a Ni(TTFtt) thin film is shown in FIG. 1B. According to an exemplary method, (SnBu₂)₂TTFtt was synthesized according to literature procedures.⁴¹ 12 mg of (SnBu₂)₂TTFtt (0.015 mmol) was placed in a vial. To this, 1.1 equivalents of the NiCl₄²⁻ salt was added after being dissolved in 1 mL of 100° C. DMF. The resulting dark blue-purple solution was filtered through a 0.22 μm syringe filter to remove undissolved particulates. This solution was dropcast onto the substrate of choice before spincoating to disperse it in an even layer. Once dried, the [(cation)₂Ni(TTFtt)] films were submerged in chlorobenzene solution containing 2.2 equivalents of benzoylferrocenium tetrakis(3,5-bis(trifluoromethyl)phenyl)-borate (Fc^{OBz}BAr^{F}₄) for 12 hours. This resulted in the full oxidation of the film to the Ni(TTFtt) materials. The films were then rinsed in DCM and MeOH to remove any contaminants from the oxidation process before further characterization.

### Example 2

### Van Der Pauw Sample Preparation

Van der Pauw substrates were fabricated. Each substrate was 5 mm² and 500 μm thick of undoped Si with an insulating layer of 100 μm thick SiO₂ deposited on top of the Si. In each corner is a 0.75 mm² gold pad. Films were deposited onto these substrates and each gold pad was wire bonded to a Quantum Design DC Resistivity puck with a K&S wedgebonder using aluminum wire. Ohmic contact of each sample was checked before each experiment by sweeping the current and making sure there was a linear voltage response.

### Example 3

### Fabrication of Conductive Nylon-Ni(TTFtt) Textiles

A 2×1 cm rectangle of nylon was submerged in 0.5 mL of [(cation)₂Ni(TTFtt)] solution then dried under a heat lamp. This process was repeated until the entire solution had been absorbed into the nylon fabric. The resulting fabric was submerged in a chlorobenzene solution containing 2.2 equivalents of Fc^{OBz}BAr^{F}₄ for 12 hours. The fabrics were then rinsed in DCM and MeOH to remove any contaminants from the oxidation process and then dried in air. Silver paint was used to install contacts on both 1 cm sides of the rectangle to increase ease of resistance measurements.

### Example 4

### Characterization and Spectroscopic Methods

### Scanning Laser Confocal Microscopy:

Optical and height images were collected with an Olympus OLS5000 LEXT laser confocal microscope. The height images were collected with a 100× zoom objective lens using the multi-area stitching mode over a 500×500 μm area. Olympus OLS software was used to remove noise from these images by setting algorithmically determined noise as a non-measurement point. Tilt in the images was removed by defining a plane of 4 points on the surface of the substrate without film present. The error in the height profiles is 5 nm.

### PXRD:

Powder X-ray diffraction (PXRD) patterns were collected on a Rigaku benchtop MiniFlex instrument for all samples. The MiniFlex is equipped with a 600 W Cu X-ray tube and HyPix-400 2D hybridpixel array detector. Data were collected in a Bragg-Brentano reflection mode. Films on Si/SiO₂ were held in place on a zero-background Si block with H-Grease.

### GIWAXS:

GIWAXS measurements were performed on a SAXSLAB Ganesha equipped with a Xenocs GeniX3D Cu Kα source. The Ni(TTFtt) film on Si/SiO₂ was loaded on the sample stage by double-side tape.

### SEM and SEM-EDS:

SEM imaging and EDX elemental mapping were performed in a Carl Zeiss Merlin Field-Emission Scanning Electron Microscope equipped with Oxford Ultim Max 100 Silicon Drift Detectors (SDD). The films were fixed on conductive tape substrates before measurements.

### AFM:

AFM images were collected on a Bruker Multimode 8 using ScanAsyst mode. The images were minimally processed, for each shown in the SI the minimum value was set to 0 and the data was leveled to make facets point upwards.

### XPS:

XPS spectra were collected on an AXIS Nova spectrometer (Kratos Analytical) equipped with a monochromatic Al Kα X-ray source. The instrument work function was calibrated to give an Au 4f 7/2 metallic gold binding energy of 83.95 eV. For calibration purposes, the binding energies were referenced to the C 1s peak at 284.8 eV. Survey spectra were collected using 160 eV pass energy (step size 1 eV). To confirm full oxidation of the films and no cation trapping, Ar cluster etching was performed. The etching was accomplished using a multi-modal Gas Cluster Ion Source gun that allowed a choice of Ar cluster size and corresponding energy. To allow for many etch cycles of ~5 nm removed/etch, very gentle etching conditions such as Ar 1000+ cluster energized at 5 keV were chosen. Etching was stopped when the Si signal from the substrate stopped gaining intensity in the XPS spectrum.

### Raman Spectroscopy:

Raman spectra were obtained with a Horiba LabRamHR Evolution confocal microscope. A Si(111) wafer was used for calibration. A 3 μm thick NiTTFtt film on a mylar substrate was excited using a 532 nm light source operating at 5% of its power and using 100× long path objective and a 600 mm⁻¹ grating. Data were normalized to the highest peak intensity using Spectragryph and multipoint baseline corrections were performed.

### Example 5

### Conductivity Measurements

All electrical measurements were performed in a physical property measurement system (PPMS, Quantum Design) under He-filled inert atmosphere. Variable temperature resistance and magnetoresistance measurements were performed using a Keithley multimeter (Keithley 2636A) controlled by a LabVIEW interface. In all experiments current was kept constant between two adjacent contacts on the van der Pauw substrates and the change in voltage between the other two contacts was measured. For variable temperature experiments, the data was output directly as resistance, in magnetoresistance experiments, the voltage was measured and converted into resistance by dividing the voltage by the current.

Magnetoresistance was determined by a method analogous to Hall effect measurements, to account for potential voltage drift over time.⁴² The Magnetic field was swept between zero field, and positive and negative fields and the change in voltage was monitored simultaneously. The magnetoresistance was calculated by subtracting the zero-field voltage from the voltage at a given field, then divided by the applied current to give resistance. This value was then converted into a percentage.

### Example 6

### Textile Weathering

Conductive nylon textiles were weathered in a variety of ways. Textiles were bent in half 1,000 times and two-point resistance was monitored every 100 bend cycles. Textiles were submerged in brine (with care taken to not contaminate the silver contacts) (saturated NaCl), 1 M NaOH, and 1 M HCl and allowed to dry. After drying, the change in two-point resistance was measured. See Table 1, below.

TABLE 1
Changes in Resistance Due to Different Weathering Tests.

| Test | ΔR % |
|---|---|
| Laundering | 107 |
| Acid Exposure (1M HCl) | 9 |
| Base Exposure (1M NaOH) | 8 |
| Brine Exposure (saturated NaCl) | 25 |

To investigate the effect of detergent washing on the conductive textiles, a simulated laundry cycle was performed. The textiles were submerged in 40° C. water, and 10 mg of powdered detergent was added. These were then stirred for 30 minutes. After washing, the textiles were submerged in room temperature water and stirred for an additional 30 minutes before being allowed to air dry. After drying the change in two-point resistance was measured with a multimeter. See Table 1, above.

### Example 7

### Discussion of Examples 1-6

### Solution Processing and Characterization of Thin Films

Previous work on NiTTFtt materials revealed enhanced solubility (i.e. slower precipitation) of CPs when reduced TTFtt linkers were used in syntheses.²⁶ Accordingly, it was hypothesized that in-situ generation of charged chains could hinder aggregation and precipitation, and that this might in turn facilitate solution processing. Further investigation revealed that mixtures of a variety of NiCl₄²⁻ salts with neutral (SnBu₂)₂TTFtt linkers in suitably good solvents capable of disrupting the strong π-stack between the TTFtt units results in homogeneous solutions of [cation]₂NiTTFtt (cation=NH₄⁺, NMe₄⁺, and NEt₄⁺). See FIG. 1B. These solutions can then be deposited onto a variety of substrates via drop-casting, dip-coating, or spin-coating to make uniform thin films. Subsequent curing in a PhCl solution of Fc^{OBz}BAr^{F}₄ generates NiTTFtt via oxidation and cation extrusion.

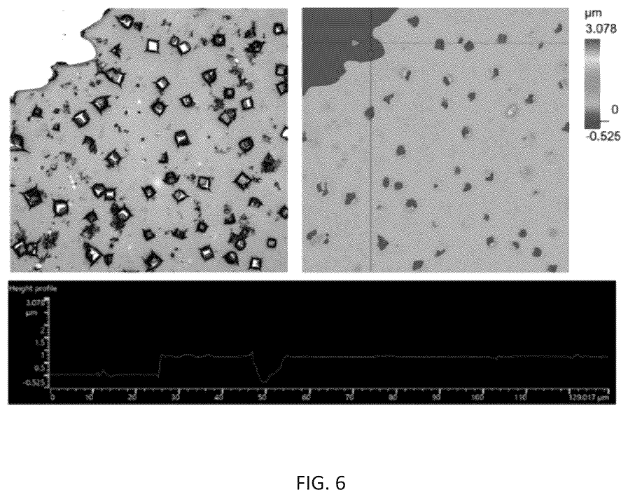

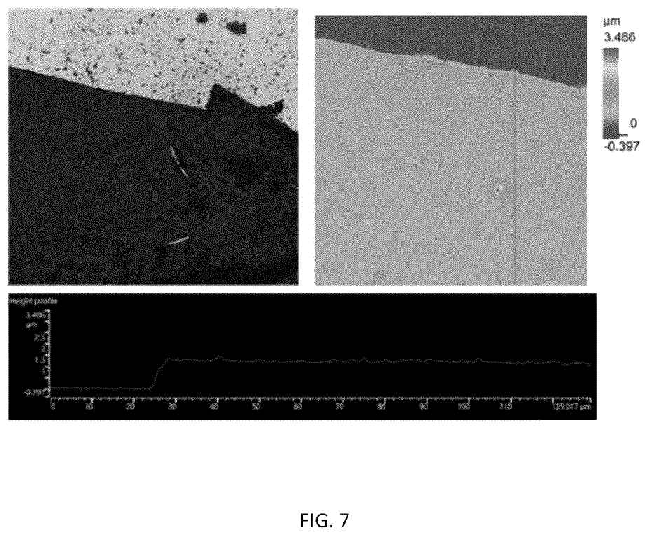

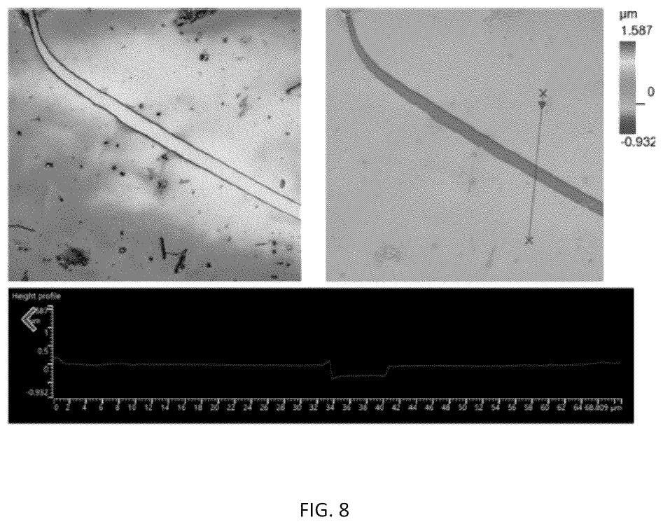

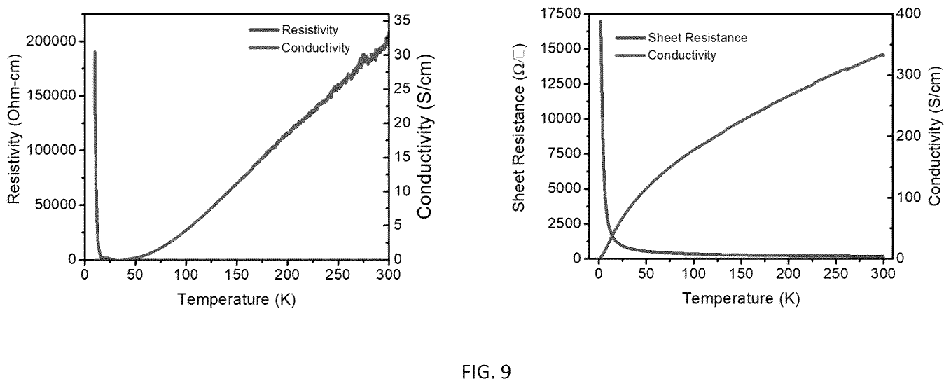

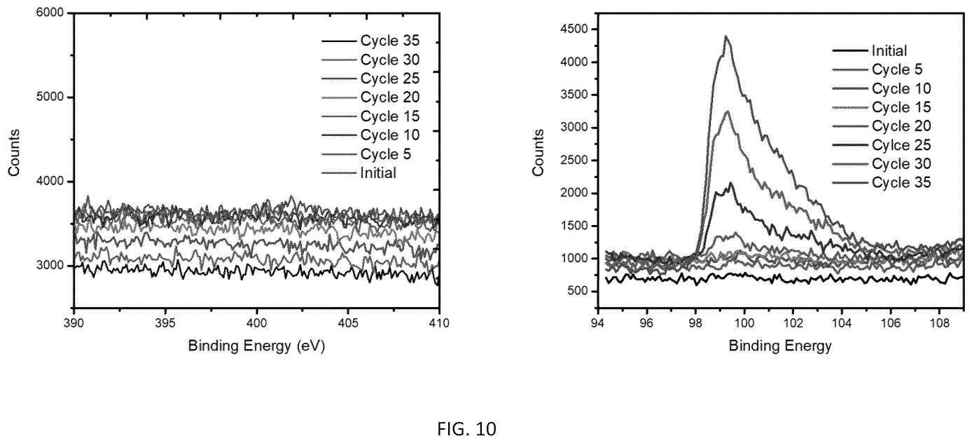

The cation used in the synthesis of the NiTTFtt films can play a large role in determining film quality. NH₄⁺, NMe₄⁺, and NEt₄⁺ were all screened for their suitability in this deposition technique. Films made with NH₄⁺ showed many defects (see FIG. 6), while films made with the large cations were far more uniform. See FIGS. 7 and 8. However, when the conductivity of films oxidized from the NMe₄⁺ or NEt₄⁺ precursor solutions were compared, the NMe₄⁺ films were far more conductive. See FIG. 9. Without being bound to any one theory, it is believed that this is due to partial oxidation of the films with the bulkier NEt₄⁺ cation, which may not be able to fully diffuse from the film during oxidation. Sputtering XPS experiments on NMe₄⁺ films show no signal from N supporting that the cations have been fully extruded from the material upon oxidation. See FIG. 10.

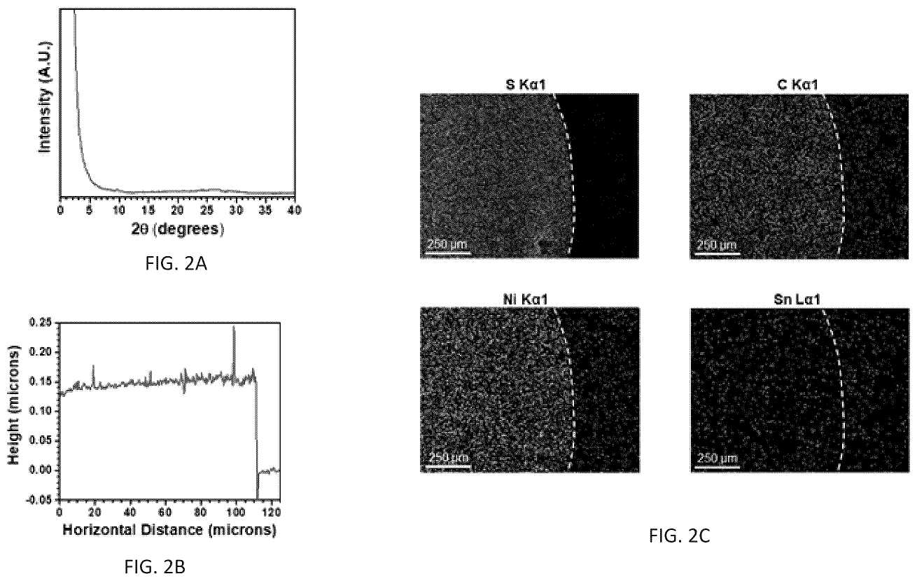

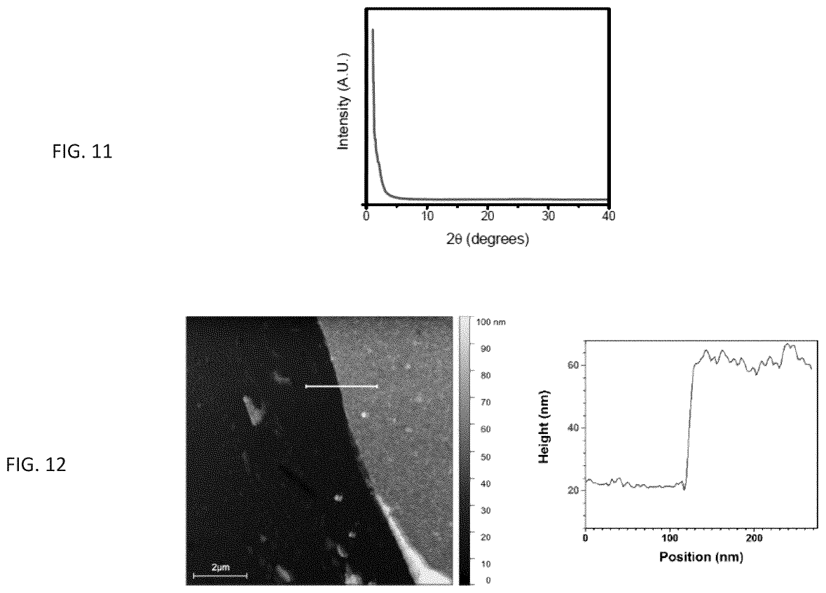

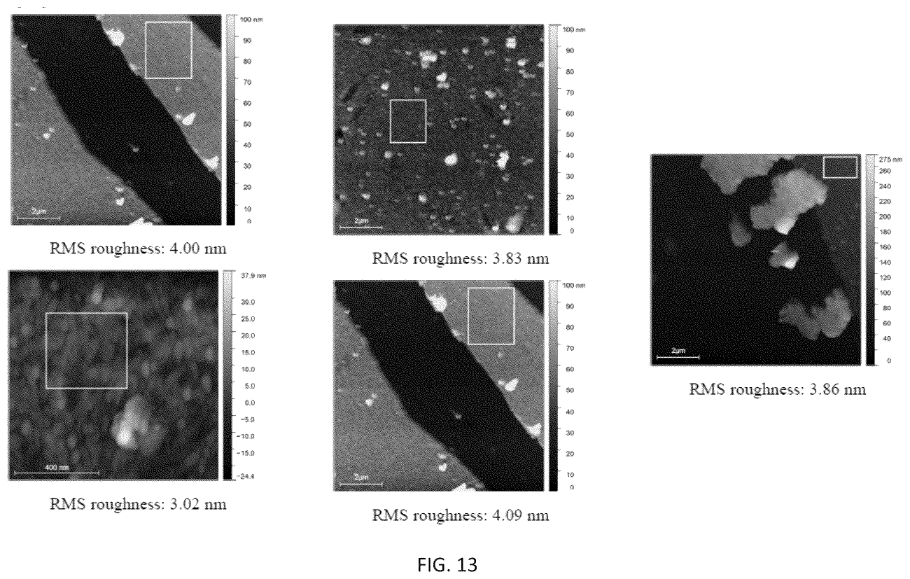

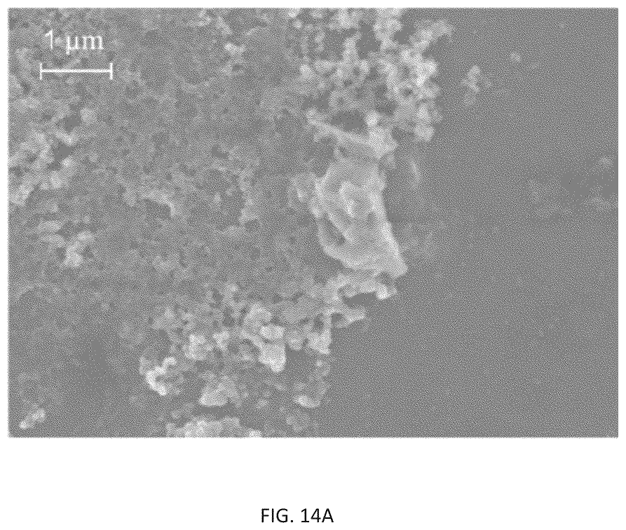

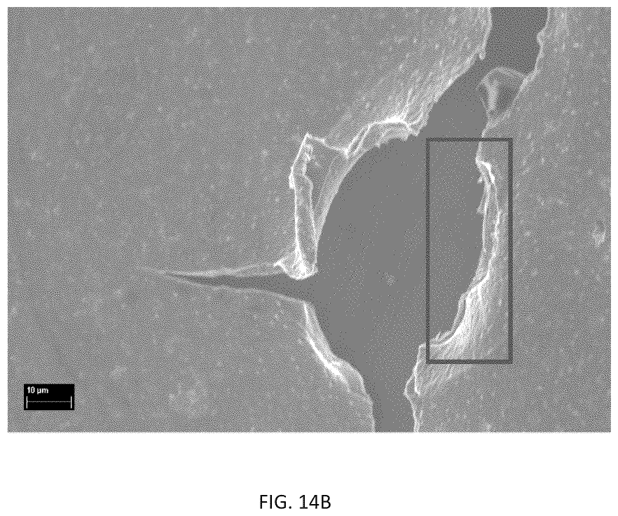

PXRD and GIWAXS experiments on NiTTFtt films are both featureless (see FIGS. 2A and 11), and height profiles generated by laser microscopy and AFM show smooth films with no long-range ordering. See FIGS. 2B, 12, and 13. SEM images also show no structural order in the films post deposition. See FIG. 14A. Some evidence of a layered morphology is also apparent from SEM analysis. See FIG. 14B. These results confirm that NiTTFtt films remain amorphous as observed for bulk powders of this material.²⁵ These films can also be deposited at a variety of thicknesses by altering the speed of the spincoater and adjusting the temperature of the surface on which they are deposited. This processing enables film thicknesses ranging from 40 nm to 3 μm. See FIGS. 7 and 12. AFM experiments confirm the uniformity of the films with RMS roughness ~10% of the total film thickness for 40 nm thick films. See FIG. 13. The films used in the conductivity and transport analyses below were either 40 nm or 150 nm thick. See FIG. 2B.

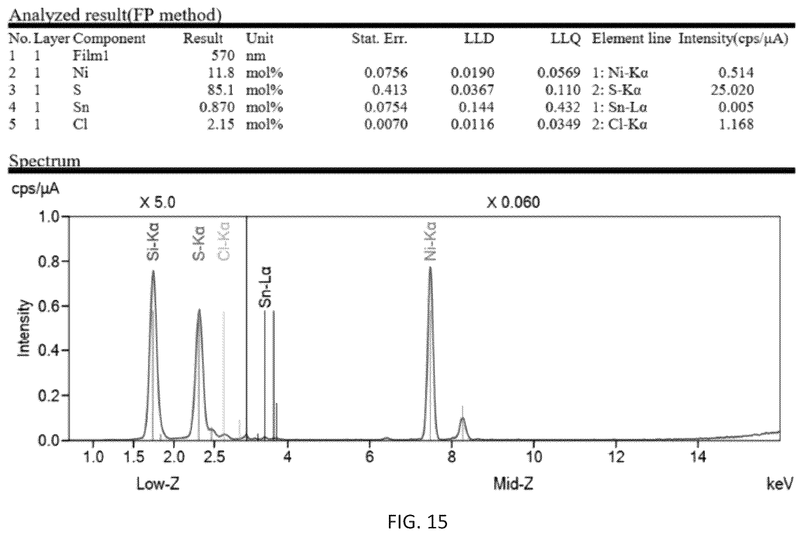

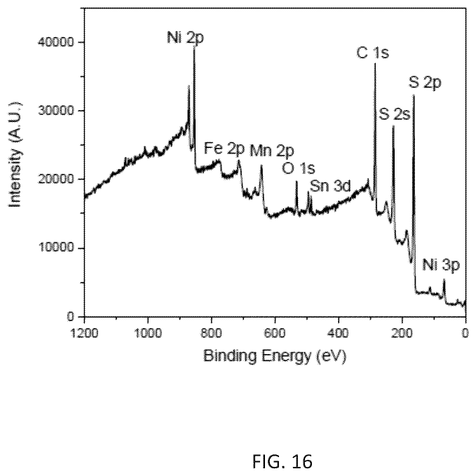

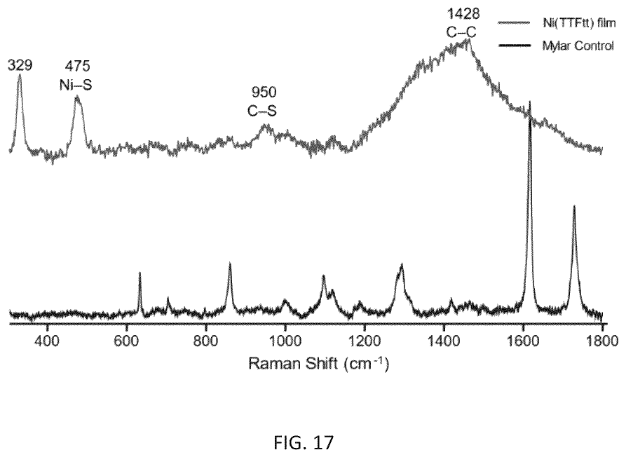

Various techniques confirm the composition of the deposited NiTTFtt films. See FIG. 2C and Table 2, below. See also FIGS. 15 and 16. The expected Ni:S ratio of 1:8 is observed by Energy Dispersive X-ray (EDS), X-ray Fluorescence (XRF), and X-ray Photoelectron (XPS) spectroscopies. Furthermore, SEM-EDS shows no formation of NiS under the changed reaction conditions that allow for film deposition. See FIG. 2C. Vibrational spectroscopy also confirms that the features of NiTTFtt remain intact post deposition; Raman spectra of NiTTFtt films (see FIG. 17) show sharp peaks at 329, 475 and 950 cm⁻¹, which are associated with TTF skeletal,²⁷ Ni—S, and C—S vibrations,^{25,26} respectively. There is also a broad and intense vibration centered at 1428 cm⁻¹ which has previously been assigned to C—C vibrations in the TTFtt moiety.^{25,26} All of these data establish that thin films of NiTTFtt with high compositional purity and uniformity can be generated with the synthetic approach shown in FIG. 1B.

TABLE 2
Ni:S Ratio of NiTTFtt films as Measured by Different Techniques.

| Technique | Ni:S Ratio |
|---|---|
| XPS | 1:11 |
| XRF | 1.2:8.5 |
| EDS | 1.7:8.3 |

### Conductivity and Transport Measurements

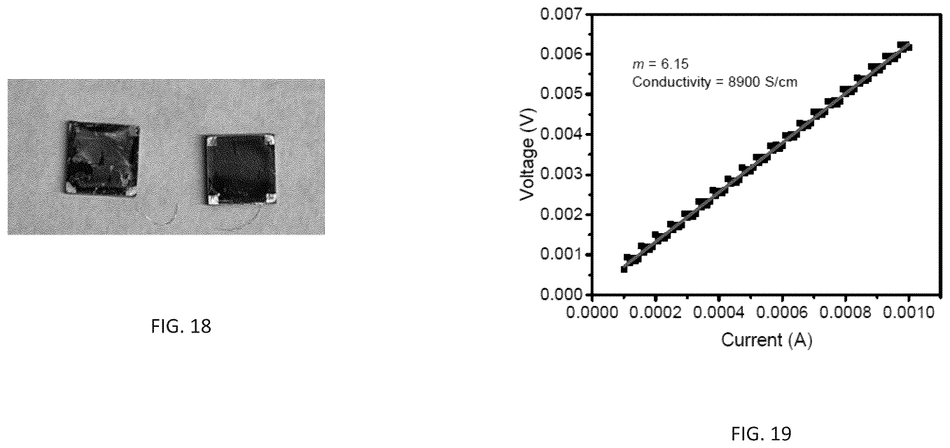

It was hypothesized that thin films of NiTTFtt would have fewer grain boundaries than in the previously studied pressed pellets. As such, this motivated an in-depth analysis of the conductivity and transport mechanisms in these newly synthesized NiTTFtt thin films. Films were deposited onto van der Pauw substrates. See FIG. 18. Room temperature measurements over multiple samples support that NiTTFtt is highly conductive. The average conductivity of this thin films is 2(2)×10³ S/cm (see Table 3, below) with a ceiling value for a single film of 8900 S/cm. See FIG. 19. This value represents a new record for conductivity in a coordination polymer.

TABLE 3
Conductivities and Statistics of Various Thin Film Samples

| Sample | Conductivity* | | | |
|---|---|---|---|---|
| Number | (S/cm) | Median | Mean | Std. Dev. |
| 1 | 8986 | 1306 | 2120 | 2461 |
| 2 | 1414 | — | — | — |
| 3 | 849 | — | — | — |
| 4 | 1199 | — | — | — |
| 5 | 574 | — | — | — |
| 6 | 1532 | — | — | — |
| 7 | 2189 | — | — | — |
| 8 | 1127 | — | — | — |
| 9 | 2202 | — | — | — |
| 10 | 1149 | — | — | — |

*The variability of the conductivity is caused by defects in the films from either deposition or handling conditions. The films can be fragile once deposited on hard substrates. Differences in film thickness are accounted for during the conversion of sheet resistance to conductivity, as sheet resistance is multiplied by thickness to get resistivity, the inverse of conductivity.

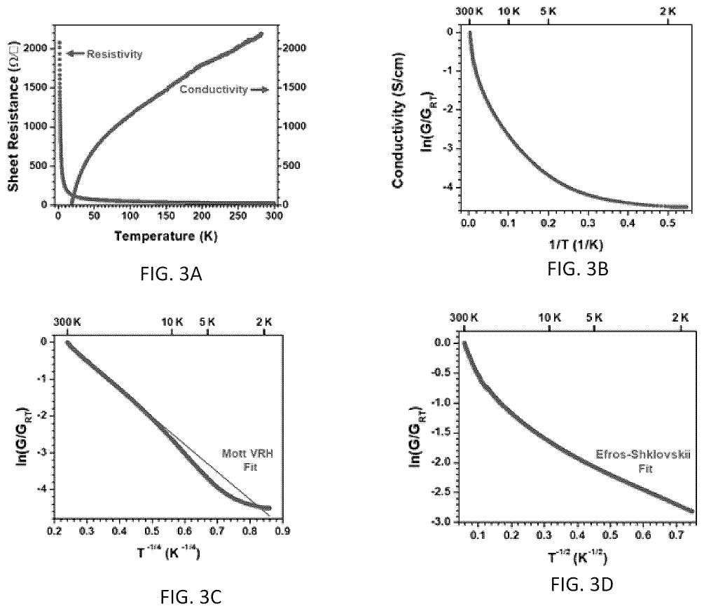

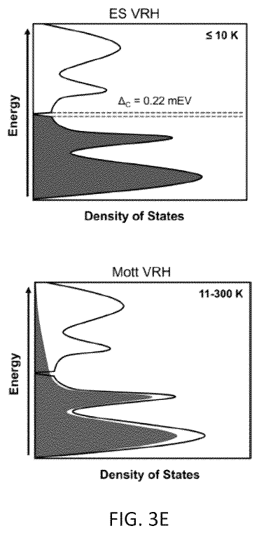

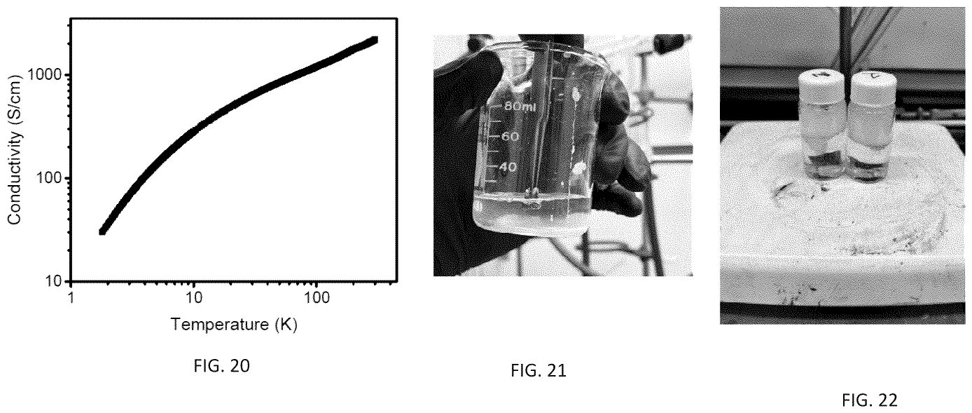

Variable temperature conductivity experiments on NiTTFtt thin films give results that are similar to the bulk material. The sheet resistance of these films is flat and nearly unchanging until low temperatures where it exhibits a sharp increase. See FIG. 3A. This behavior is typical of glassy metals and related disordered conductors.² To better understand the mechanism of charge transport in these films, and compare them to the bulk material, various fits were applied to the variable temperature conductivity data. A plot of log(conductivity) vs log(T) (see FIG. 20) shows two linear regions with a transition temperature at ~10 K, which suggests that two mechanisms of conduction contribute to charge transport. Arrhenius analysis of these data (see FIG. 3B) shows no linear region from which to derive a semiconducting activation energy—a marked difference from the bulk material. Without being bound to any one theory, it is believed that the activation energy derived from experiments on the bulk material is affected by hopping barriers between domains and/or grains.²⁵

$${σ}_{VRH} = {σ}_{0} exp [ {( - \frac{{T}_{0}}{T} )}^{x} ] \qquad Equation ( 1 )$$

Other analyses of the variable temperature conductivity data, including variable range hopping (VRH) analyses, paint a fuller picture of the charge transport mechanism of NiTTFtt. Equation 1 describes VRH, where σ₀ is a conductivity prefactor, T₀ is a characteristic temperature, and x is related to the dimensionality of a specific hopping model. A Mott Variable Range Hopping fit of the data shows a linear region above 10 K, with significant deviation below that temperature. See FIG. 3C. The slope of the linear region gives a T₀ of 6.24 K, which is typical of glassy metals.^{2,28} These data also suggest that transport is dominated by thermally-driven hopping with a very low activation energy above 10 K (vide supra). The data below 10 K is better fit with an Efros-Shklovskii (ES) Hopping model (x=½). See FIG. 3D.

This gives a good linear fit below 10 K and a T_{ES} of 2.5 K. These data indicate that at low temperatures electron-electron repulsion leads to depopulation of the Fermi level and the opening of a Coulomb gap in NiTTFtt, such as a 0.22 meV Coulomb gap in NiTTFtt (FIG. 3E, calculated from Equation (2), where T_{ES} is the Efros-Shklovskii temperature, and T_{C} is the temperature where Mott VRH transitions to Efros-Shklovskii Hopping (ESH), ~10 K).²⁹ Thus, a mix of hopping mechanisms contribute to transport in these thin films. Such behavior is well established in amorphous metals^{30,31} and related semiconducting quantum dot systems.^{32,33}

Δc=0.5(T_{ES}T_{c})^{1/2} Equation (2)

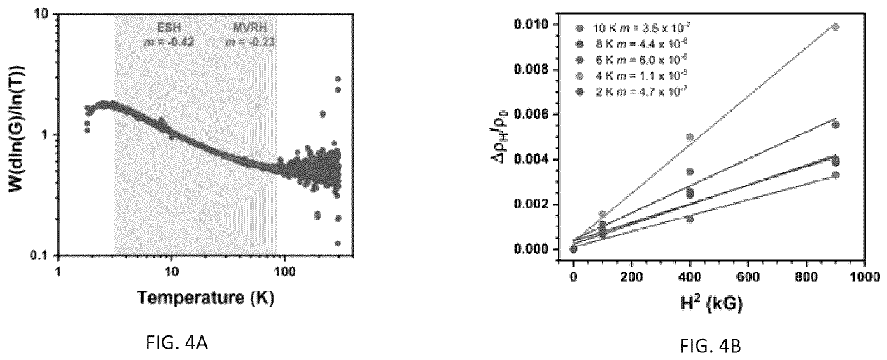

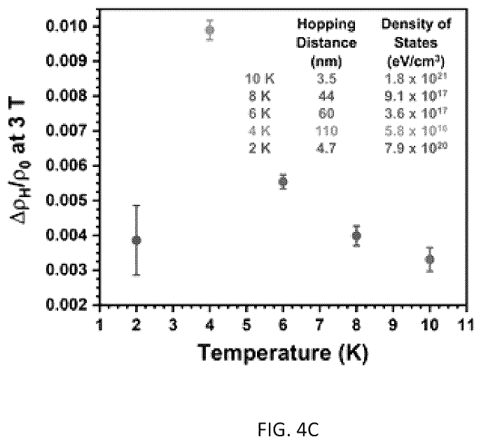

To further analyze the transition between Mott and ES hopping, a reduced activation energy plot of the VT conductivity data was analyzed. Above 100 K, the data are challenging to fit due to the relatively small change in ln(σ). Below 100 K, this plot shows two linear regions. The region between 100 and 12 K is fit with a slope of −0.23, suggesting a MVRH transport mechanism in this temperature range and consistent with our other analyses. The region between 12 and 3 K is best fit with a slope of −0.42, which is close to the expected −0.5 value for ESH conduction. More interestingly, a clear transition at 2 K-3 K to metallic behavior is observed. See FIG. 4A. Such metal-to-insulator transitions have been observed previously in glassy metals.^{31,34,35} To confirm this transition, magnetoresistance experiments were performed. Magnetoresistance data can be used to find both hopping distance, and calculate the density of states at the Fermi level.³¹ NiTTFtt films exhibit positive magnetoresistance below 10 K. See FIG. 4B. Positive magnetoresistance is a hallmark of metallic behavior,³⁰ and shows that transport at these temperatures is dominated by the Zeeman term and not localization effects.^{36,37} The magnetoresistance data also confirms that ES hopping dominates <10 K, as the magnetoresistive effect is proportional to magnetic field squared at these temperatures. See FIG. 4B. The slopes of these lines also give the hopping distance in cm.³⁸ Satisfyingly, the magnetoresistance rises upon cooling to 4 K, but drops upon further cooling. This behavior confirms the metal-to-insulator transition observed in the reduced activation energy plot of the VT conductivity data. Using equation (3) (where No is the density of states, ξ is the hopping distance in cm, and k_{B} is the Boltzmann constant in eV), the T₀ from the Mott Hopping fit, and the hopping distances from the magnetoresistance data, the density of states at a given temperature can be calculated:

$${T}_{0} = \frac{21.2}{{k}_{B} {N}_{0} {ξ}^{3}} . \qquad Equation ( 3 )$$

The calculated density of states show a remarkable repopulation of the Fermi level at low temperatures. See FIG. 4C. This further supports the metal-to-insulator transition and suggests that at sufficiently low temperatures a change in either the physical or electronic structure of NiTTFtt might enable a new mechanism for conduction. Further investigations of the low-temperature transport properties of this material are a promising area of investigation.

### Robust Conductive Coatings

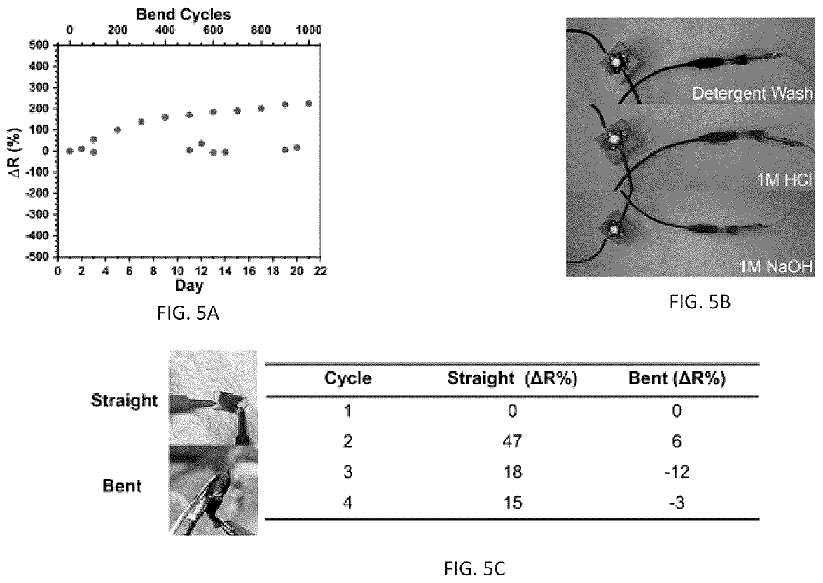

Bulk NiTTFtt exhibits notable long-term stability under a variety of harsh conditions.²⁵ Given the new material morphology presented here, a study was performed to ensure that the stability of the films was also maintained. To test this, a thin film was left in air for 20 days and the two-point resistance was measured. Over this time frame the two-point resistance did not significantly change (<10%), indicating that no significant decay of the thin films over this time in air. See FIG. 5A.

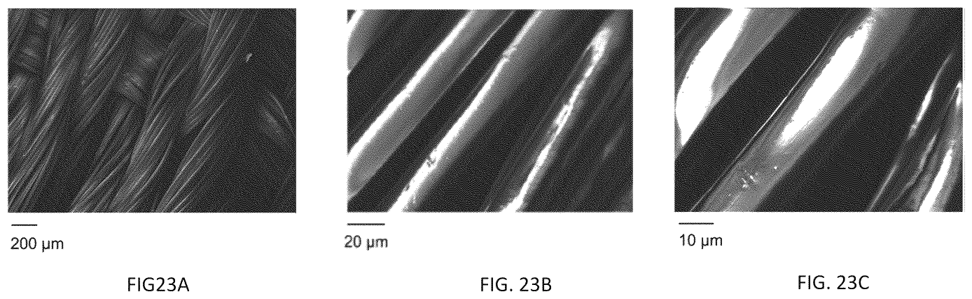

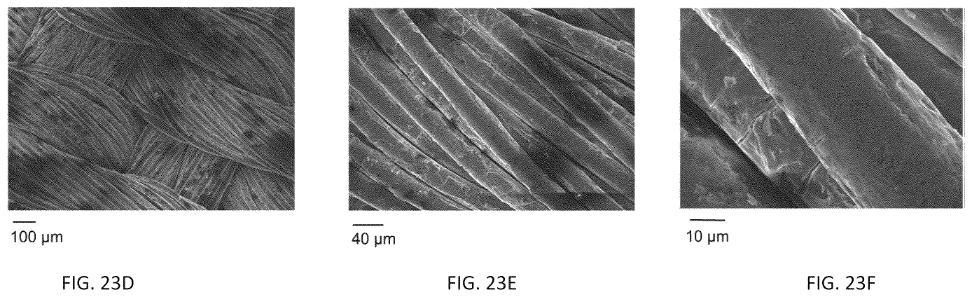

Encouraged by the long-term stability and solution processability of NiTTFtt, potential applications of this material were explored. Conductive textiles and fibers underpin a number of technologies, and other conductive polymers—such as PEDOT:PSS—have been applied to textiles to transform them into conductive materials.³⁹ Accordingly, nylon fibers were dip-coated in [(NMe₄)₂NiTTFtt]ₙ and these materials were cured in a process analogous to the thin films to successfully synthesize conductive textiles. SEM images of these textiles show that the nylon fibers are fully coated with NiTTFtt (FIGS. 23A-23F). In FIGS. 23B and 23C, the glowing, bright area is due to the charging effect caused by the insulating nature of nylon. Such an effect was not observed in FIGS. 23D to 23F, supporting that the Ni(TTFtt) coating increases the conductivity of the fabric. These coated materials exhibit a high level of robustness with respect to manipulation, and exposure to both normal and harsh conditions. See FIGS. 5A and 5B. The two-point resistance of these coated fabrics was measured over 1000 iterations of bending cycles and the resistance changed only ~2 fold over that time. The textiles were also resilient to being soaked in 1 M acid and base, as well as brine. See FIGS. 5B and 21. Washing with a detergent mixture similarly yielded only small changes (a ~2× increase) in the two-point resistance of the NiTTFtt coated textiles. See FIG. 22. These fabrics also maintain similar conductivity upon mechanical stress: the two-point resistance of the textiles does not change significantly from bent or straight geometries. See FIG. 5C. Without being bound to any one theory it is hypothesized that the innately disordered nature of NiTTFtt underpins its remarkable durability to a range of forcing environments. This durability also is particularly appealing for possible applications.

### Outlook

Conductive coordination polymers are an emerging class of materials with a variety of potential applications. Herein is reported the first example of solution processing of a highly conducting coordination polymer, NiTTFtt, which provides record conductivity. The presently disclosed solution processing provides incorporation of conducting coordination polymers into functional materials and measurement devices. Characterization of thin films of NiTTFtt show that it has the same composition as the bulk material and retains the same disorder-enabled stability. Furthermore, thin films of NiTTFtt have enabled greater insight into the physics that underlie its remarkable conductivity and have opened the door for future low-temperature studies on this unique material. Solution processing of NiTTFtt provided particularly robust conductive textiles. The findings presented here show that coordination polymers are viable as processable alternatives to traditional conducting polymers in functional materials. See FIG. 1A.

### REFERENCES

All references listed herein including but not limited to all patents, patent applications and publications thereof, scientific journal articles, and database entries are incorporated herein by reference in their entireties to the extent that they supplement, explain, provide a background for, or teach methodology, techniques, and/or compositions employed herein.
(1) Guo, X.; Facchetti, A. Nat. Mater. 2020, 19 (9), 922-928.
(2) Kaiser, A. B. Reports Prog. Phys. 2001, No. 64, 1-49.
(3) Celzard, A.; Marěché, J. F.; Furdin, G.; Puricelli, S. J. Phys. D. Appl. Phys. 2000, 33 (23), 3094-3101.
(4) Wang, L. W.; Metcalf, S. J.; Critoph, R. E.; Thorpe, R.; Tamainot-Telto, Z. Carbon N. Y. 2011, 49 (14), 4812-4819.
(5) Novoselov, K. S.; Geim, A. K.; Morozov, S. V.; Jiang, D.; Zhang, Y.; Dubonos, S. V.; Grigorieva, I. V.; Firsov, A. A. Science. 2004, 306, 666-669.
(6) Rao, R.; Pint, C. L.; Islam, A. E.; Weatherup, R. S.; Hofmann, S.; Meshot, E. R.; Wu, F.; Zhou, C.; Dee, N.; Amama, P. B.; Carpena-Nuñez, J.; Shi, W.; Plata, D. L.; Penev, E. S.; Yakobson, B. I.; Balbuena, P. B.; Bichara, C.; Futaba, D. N.; Noda, S.; Shin, H.; Kim, K. S.; Simard, B.; Mirri, F.; Pasquali, M.; Fornasiero, F.; Kauppinen, E. I.; Arnold, M.; Cola, B. A.; Nikolaev, P.; Arepalli, S.; Cheng, H. M.; Zakharov, D. N.; Stach, E. A.; Zhang, J.; Wei, F.; Terrones, M.; Geohegan, D. B.; Maruyama, B.; Maruyama, S.; Li, Y.; Adams, W. W.; Hart, A. J. ACS Nano 2018, 12 (12), 11756-11784.
(7) Tans, S. J.; Zhang, L.; Wang, N.; Zhang, X. X.; Wen, G. H.; Li, G. D.; Wang, J. N.; Chan, C. T.; Sheng, P. Nature 1997, 386 (APRIL), 474-477.
(8) Muhl, S.; Aguilar Osorio, R.; Martínez Huitle, U. A. Rev. Mex. Fis. 2014, 63 (5), 439-447.
(9) Lee, K.; Cho, S.; Sung, H. P.; Heeger, A. J.; Lee, C. W.; Lee, S. H. Nature 2006, 441 (1), 65-68.
(10) Chiang, C. K.; Fincher, C. R.; Park, Y. W.; Shirakawa, H.; Louis, E. J.; Gau, S. C.; MacDiarmid, A. G.; Heeger, A. J. Phys. Rev. Lett. 1977, 39 (17), 1098-1101.
(11) Shahrim, N. A.; Ahmad, Z.; Wong Azman, A.; Fachmi Buys, Y.; Sarifuddin, N. Mater. Adv. 2021, 2 (22), 7118-7138.
(12) Yeon, C.; Yun, S. J.; Kim, J.; Lim, J. W. Adv. Electron. Mater. 2015, 1(10), 1-8.
(13) Lee, H. C.; Liu, W.-W.; Chai, S.-P.; Mohamed, A. R.; Lai, C. W.; Khe, C.-S.; Voon, C. H.; Hashim, U.; Hidayah, N. M. S. Procedia Chem. 2016, 19, 916-921.
(14) Wang, M.; Huang, M.; Luo, D.; Li, Y.; Choe, M.; Seong, W. K.; Kim, M.; Jin, S.; Wang, M.; Chatterjee, S.; Kwon, Y.; Lee, Z.; Ruoff, R. S. Nature 2021, 596 (7873), 519-524.
(15) Flynt, J. What is Conductive Paint? Pros, Cons, and Applications https://3dinsider.com/conductive-paint/.
(16) Valade, L.; de Caro, D.; Faulmann, C.; Jacob, K. Coord. Chem. Rev. 2016, 308, 433-444.
(17) Bryce, M. R. Chem. Soc. Rev. 1991, 20 (3), 355-390.
(18) Xie, L. S.; Skorupskii, G.; Dincǎ, M. Chem. Rev. 2020, 120 (16), 8536-8580.
(19) Skorupskii, G.; Le, K. N.; Cordova, D. L. M.; Yang, L.; Chen, T.; Hendon, C. H.; Arguilla, M. Q.; Dincǎ, M. Proc. Natl. Acad. Sci. U.S.A. 2022, 119 (34).
(20) Dou, J. H.; Sun, L.; Ge, Y.; Li, W.; Hendon, C. H.; Li, J.; Gul, S.; Yano, J.; Stach, E. A.; Dincǎ, M. J. Am. Chem. Soc. 2017, 139 (39), 13608-13611.
(21) Jin, Z.; Yan, J.; Huang, X.; Xu, W.; Yang, S.; Zhu, D.; Wang, J. Nano Energy 2017, 40 (August), 376-381.
(22) Takenaka, T.; Ishihara, K.; Roppongi, M.; Miao, Y.; Mizukami, Y.; Makita, T.; Tsurumi, J.; Watanabe, S.; Takeya, J.; Yamashita, M.; Torizuka, K.; Uwatoko, Y.; Sasaki, T.; Huang, X.; Xu, W.; Zhu, D.; Su, N.; Cheng, J. G.; Shibauchi, T.; Hashimoto, K. Sci. Adv. 2021, 7(12), 1-7.
(23) Dhainaut, J.; Bonneau, M.; Ueoka, R.; Kanamori, K.; Furukawa, S. ACS App. Mater. Interfaces 2020, 12 (9), 10983-10992.
(24) Eagleton, A. M.; Ko, M.; Stolz, R. M.; Vereshchuk, N.; Meng, Z.; Mendecki, L.; Levenson, A. M.; Huang, C.; Macveagh, K. C.; Mahdavi-Shakib, A.; Mahle, J. J.; Peterson, G. W.; Frederick, B. G.; Mirica, K. A. J. Am. Chem. Soc. 2022, 144 (51), 23297-23312.
(25) Xie, J.; Ewing, S.; Boyn, J. N.; Filatov, A. S.; Cheng, B.; Ma, T.; Grocke, G. L.; Zhao, N.; Itani, R.; Sun, X.; Cho, H.; Chen, Z.; Chapman, K. W.; Patel, S. N.; Talapin, D. V.; Park, J.; Mazziotti, D. A.; Anderson, J. S. Nature 2022, 611 (7936), 479-484.
(26) Xie, J.; Pan, J. A.; Cheng, B.; Ma, T.; Filatov, A. S.; Patel, S. N.; Park, J.; Talapin, D. V.; Anderson, J. S. J. Am. Chem. Soc. 2022, 144 (41), 19026-19037.
(27) De Caro, D.; Fraxedas, J.; Faulmann, C.; Malfant, I.; Milon, J.; Lamere, J. F.; Colliere, V.; Valade, L. Adv. Mater. 2004, 16 (9-10), 835-838.
(28) Halim, J.; Moon, E. J.; Eklund, P.; Rosen, J.; Barsoum, M. W.; Ouisse, T. Phys. Rev. B 2018, 98 (10), 1-11.
(29) Efros, A. L.; Shklovskii, B. I. J. Phys. C Solid State Phys. 1975, 8 (4).
(30) Abkemeier, K. M.; Adkins, C. J.; Asal, R.; Davis, E. A. J. Phys. Condens. Matter 1992, 4 (46), 9113-9130.
(31) Rogatchev, A.; Mizutani, U. Phys. Rev. B—Condens. Matter Mater. Phys. 2000, 61 (23), 15550-15553.
(32) Liu, H.; Pourret, A.; Guyot-Sionnest, P. ACS Nano 2010, 4 (9), 5211-5216.
(33) Guyot-Sionnest, P. J. Phys. Chem. Lett. 2012, 3 (9), 1169-1175.
(34) Chuang, C.; Puddy, R. K.; Lin, H. De; Lo, S. T.; Chen, T. M.; Smith, C. G.; Liang, C. T. Solid State Commun. 2012, 152 (10), 905-908.
(35) Joung, D.; Khondaker, S. I. Phys. Rev. B—Condens. Matter Mater. Phys. 2012, 86 (23), 1-8.
(36) Mott, N. F.; Davis, E. A. Electronic Processes in Non-Crystalline Materials, 2012th ed.; Oxford University: New York.
(37) Bishop, D. J.; Dynes, R. C.; Tsui, D. C. Phys. Rev. B 1982, 26 (2), 773-779.
(38) Pokhodnya, K.; Bonner, M.; Prigodin, V.; Epstein, A. J.; Miller, J. S. J. Phys. Condens. Matter 2013, 25(19).
(39) Lund, A.; Darabi, S.; Hultmark, S.; Ryan, J. D.; Andersson, B.; Strom, A.; Müller, C. Adv. Mater. Technol. 2018, 3 (12), 1-6.
(40) Gill, N. S.; Taylor, F. B. In Inorganic Syntheses; 1967; Vol. IX, pp. 136-142.
(41) Xie, J.; Boyn, J. N.; Filatov, A. S.; McNeece, A. J.; Mazziotti, D. A.; Anderson, J. S. Chem. Sci. 2020, 11(4), 1066-1078.
(42) Jang, J.; Liu, W.; Son, J. S.; Talapin, D. V. Nano Lett. 2014, 14(2), 653-662.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method of preparing a coordination polymer, wherein the method comprises:
(a) providing a first coordination complex having a structure of Formula (I): 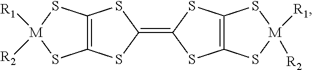
wherein:
M is a first metal selected from Si, Ge, Se, and Sn; and
R₁ and R₂ are independently selected from alkyl, aralkyl, and aryl;
(b) preparing a first solution comprising one or more second coordination complex salts dissolved in a first solvent; wherein each of said second coordination complex salts has the formula [(A)₂M′X₄], where M′ is a transition metal ion, each X is a molecule or ion having an unshared pair of electrons; and each A is monocationic molecule or ion;
(c) contacting the first coordination complex with the first solution, thereby forming a second solution comprising a coordination polymer having a structure of Formula (II): 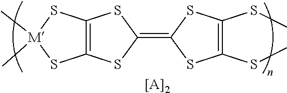
where n is an integer greater than 1, each M′ is a transition metal ion of a second coordination complex salt in the first solution of step (b), and each A is a monocationic molecule or ion from a second coordination complex salt in the first solution of step (b); and
d) depositing the second solution on a substrate, thereby forming a layer comprising the coordination polymer of Formula (II) on at least a portion of a surface of the substrate.

2. The method of claim 1, wherein M is Sn or Si.

3. The method of claim 1, wherein R₁ and R₂ are each C₁-C₆ alkyl, optionally wherein R₁ and R₂ are each butyl.

4. The method of claim 1, wherein each M′ is selected from Fe, Cr, Mo, Ni, W, Co, Cu, Pt, Pd, V, Ru, Rh, Ir, Os, Re, Au, and Mn, optionally wherein the coordination polymer of Formula (II) comprises at least two different M′, further optionally wherein each M′ is Ni, Fe, Pt, or Co.

5. The method of claim 1, wherein each X is a halide, optionally Cl or Br.

6. The method of claim 1, wherein each A is ⁺N(R′)₄, wherein each R′ is H or C₁-C₆ alkyl, optionally methyl.

7. The method of claim 1, wherein the first solvent comprises a polar aprotic or protic solvent, optionally wherein the first solvent is dimethylformamide (DMF), dimethylsulfoxide (DMSO), or a mixture thereof.

8. The method of claim 1, wherein step (b) comprises heating the first solvent, optionally wherein the heating comprises heating the first solvent to a temperature of about 60° C. to about 150° C. for a first period of time.

9. The method of claim 1, wherein the substrate comprises a textile, a fiber, silicon, glass, sapphire, metals, a thermosetting organic polymer, and/or a thermoplastic organic polymer.

10. The method of claim 1, wherein the depositing comprises printing, spraying, drop casting, spin coating, and/or dip coating.

11. The method of claim 1, wherein the method further comprises (e) curing the layer formed in step (d), wherein said curing comprises drying the layer formed in step (d) to remove the first solvent and form a film comprising the coordination polymer of Formula (II).

12. The method of claim 11, wherein the curing further comprises contacting the film comprising the coordination polymer of Formula (II) with a third solution for a second period of time, wherein the third solution comprises an oxidant and a second solvent, thereby converting the coordination polymer of Formula (III) into a conductive coordination polymer having a structure of Formula (III): 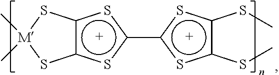
wherein n is an integer greater than 1 and each M′ is a transition metal of a second coordination polymer salt from step (b), optionally wherein the conductive coordination polymer of Formula (III) comprises at least two different M′ and/or wherein each M′ is Ni, Pt, Fe, or Co.

13. The method of claim 12, wherein the oxidant is a ferrocenium compound, optionally an acetyl ferrocenium compound or a benzoyl ferrocenium compound.

14. The method of claim 13, wherein the ferrocenium compound is a salt of a borate anion, optionally wherein the borate anion is tetrakis(3,5-bis(trifluoromethyl)phenyl) borate.

15. The method of claim 12, wherein the second solvent comprises chlorobenzene or dichloromethane.

16. A thin film comprising a conductive coordination polymer of Formula (III) prepared by the method of claim 12.

17. The thin film of claim 16, wherein the thin film has a thickness of about 20 nanometers (nm) to about 3 micrometers (μm), optionally about 40 nm to about 150 nm.

18. The thin film of claim 16, wherein the thin film has a conductivity of about 100 Siemens per centimeter (S/cm) or more, optionally about 500 S/cm to about 9000 S/cm.

19. A coated object comprising:
(i) a substrate; and
(ii) a coating layer covering at least a portion of a surface of the substrate, wherein the coating layer comprises a coordination polymer of Formula (II) prepared by a method comprising:
(a) providing a first coordination complex having a structure of Formula (I): 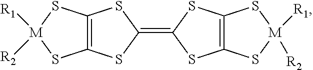
wherein:
M is a first metal selected from Si, Ge, Se, and Sn; and
R₁ and R₂ are independently selected from alkyl, aralkyl, and aryl;
(b) preparing a first solution comprising one or more second coordination complex salts dissolved in a first solvent; wherein each of said second coordination complex salts has the formula [(A)₂M′X₄], where M′ is a transition metal ion, each X is a molecule or ion having an unshared pair of electrons; and each A is monocationic molecule or ion;
(c) contacting the first coordination complex with the first solution, thereby forming a second solution comprising a coordination polymer having a structure of Formula (II): 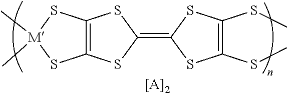
where n is an integer greater than 1, each M′ is a transition metal ion of a second coordination complex salt in the first solution of step (b), and each A is a monocationic molecule or ion from a second coordination complex salt in the first solution of step (b); and
d) depositing the second solution on a substrate, thereby forming a layer comprising the coordination polymer of Formula (II) on at least a portion of a surface of the substrate; or
wherein the coating layer comprises a conductive coordination polymer of Formula (III) prepared by a method comprising:
(a) providing a first coordination complex having a structure of Formula (I): 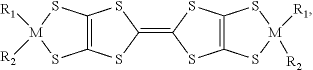
wherein:
M is a first metal selected from Si, Ge, Se, and Sn; and
R₁ and R₂ are independently selected from alkyl, aralkyl, and aryl;
(b) preparing a first solution comprising one or more second coordination complex salts dissolved in a first solvent; wherein each of said second coordination complex salts has the formula [(A)₂M′X₄], where M′ is a transition metal ion, each X is a molecule or ion having an unshared pair of electrons; and each A is monocationic molecule or ion;
(c) contacting the first coordination complex with the first solution, thereby forming a second solution comprising a coordination polymer having a structure of Formula (II): 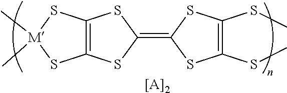
where n is an integer greater than 1, each M′ is a transition metal ion of a second coordination complex salt in the first solution of step (b), and each A is a monocationic molecule or ion from a second coordination complex salt in the first solution of step (b); and
d) depositing the second solution on a substrate, thereby forming a layer comprising the coordination polymer of Formula (II) on at least a portion of a surface of the substrate, wherein the method further comprises (e) curing the layer formed in step (d), wherein said curing comprises drying the layer formed in step (d) to remove the first solvent and form a film comprising the coordination polymer of Formula (II) and wherein the curing further comprises contacting the film comprising the coordination polymer of Formula (II) with a third solution for a second period of time, wherein the third solution comprises an oxidant and a second solvent, thereby converting the coordination polymer of Formula (III) into a conductive coordination polymer having a structure of Formula (III): 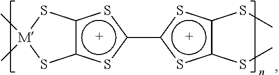
wherein n is an integer greater than 1 and each M′ is a transition metal of a second coordination polymer salt from step (b), optionally wherein the conductive coordination polymer of Formula (III) comprises at least two different M′ and/or wherein each M′ is Ni, Pt, Fe, or Co.

20. The coated object of claim 19, wherein the substrate comprises a textile, a fiber, silicon, glass, sapphire, metals, a thermosetting organic polymer, and/or a thermoplastic organic polymer.

21. The coated object of claim 19, wherein the coating layer has a thickness of about 20 nm to about 3 μm, optionally about 40 nm to about 150 nm.

22. A thin film comprising a conductive coordination polymer having a structure of Formula (III): 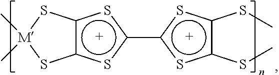
wherein n is an integer greater than 1 and each M′ is a transition metal, wherein said thin film has a thickness of about 20 nm to about 3 μm.

23. The thin film of claim 22, wherein the thin film has a conductivity of about 100 Siemens per centimeter (S/cm) or more, optionally about 500 S/cm to about 9000 S/cm.

24. The thin film of claim 22, wherein each M′ is selected from Fe, Cr, Mo, Ni, W, Co, Cu, Pt, Pd, V, Ru, Rh, Ir, Os, Re, Au, and/or Mn, optionally wherein each M′ is Ni, Pt, Fe, or Co.

25. The thin film of claim 22, wherein the thin film is stable to air, brine, detergents, aqueous solutions comprising 1 molar (M) acid, and aqueous solutions comprising 1 M base.

26. A coated object comprising a thin film of claim 22.

27. The use of a coated object of claim 26 in an electronic device.

28. A conductive textile comprising a thin film of claim 22 and a textile comprising one or more natural or synthetic fibers.

29. The conductive textile of claim 28, wherein the textile comprises nylon fibers.

30. The use of the conductive textile of claim 28 in a wearable electronic device.

31. A method of preparing a conductive coordination polymer comprising complexes of a transition metal ion and tetrathiafulvalenetetrathiolate (TTFtt), said method comprising deposition of a solution comprising a charged precursor coordination polymer and post-deposition oxidation.
